(19) United States
(12) Patent Application Publication
(10) Pub. No.: US 2025/0291659 A1
(43) Pub. Date: Sep. 18, 2025

(54) FOUNDATION MODEL PIPELINE FOR REAL-TIME EMBEDDED DEVICES

(71) Applicant: SoftEye, Inc., San Diego, CA (US)

(72) Inventors: Edwin Chongwoo Park, San Diego, CA (US); Aravind Natarajan, Dublin, CA (US)

(73) Assignee: SoftEye, Inc., San Diego, CA (US)

(21) Appl. No.: 19/081,924

(22) Filed: Mar. 17, 2025

Related U.S. Application Data
(60) Provisional application No. 63/565,974, filed on Mar. 15, 2024.

(51) Int. Cl. G06F 9/54

(52) U.S. Cl. CPC G06F 9/547

(57) ABSTRACT

Systems, computer programs, devices, and methods that enable LLM-based user interfaces within real-time and/or embedded devices. Providing user-specific context to a generically trained LLM may enable a variety of new usages and scenarios. For example, adaptive prompt augmentation may enable a user device to augment user-generated prompts with additional user context in the form of machine-generated prompts. In some variants, machine-generated prompts may be further refined to accommodate e.g., foundation model constraints, etc. APIs for user-specific data structures can be used to e.g., optimize for habitual behaviors, user idiosyncrasies, etc. Agentic query construction may enable a user device to operate with autonomy and decision-making capabilities, beyond prompt-response interactions. Stitching (or dreaming) may be used to identify pattern-based associations within high dimensional space (embedding vectors).

### PRIORITY

This application claims the benefit of priority to U.S. Provisional Patent Application Ser. No. 63/508,650 filed Jun. 16, 2023, and entitled “NETWORK INFRASTRUCTURE FOR USER-SPECIFIC GENERATIVE INTELLIGENCE”, and U.S. Provisional Patent Application Ser. No. 63/565,974 filed Mar. 15, 2024, and entitled “LARGE LANGUAGE MODEL PIPELINE FOR REAL-TIME EMBEDDED DEVICES”, each of the foregoing incorporated by reference in their entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of generative intelligence for user devices. More particularly, the present disclosure relates to systems, computer programs, devices, and methods that enable generative intelligence within real-time and/or embedded devices.

### DESCRIPTION OF RELATED TECHNOLOGY

Generative intelligence, also known as generative artificial intelligence (AI), refers to a class of AI models and algorithms that are designed to create new content, such as images, text, music, and even videos, by learning patterns and structures from existing examples.

A large language model (LLM) refers to a type of generative artificial intelligence model designed to generate human-like language. LLMs are trained to learn patterns, context, and word relationships, from vast amounts of text data. The trained LLM then generates a novel sequence of words for an input prompt, based on its training. LLMs have been used for a variety of natural language processing tasks, including text generation, translation, summarization, and question-response. Conventional LLMs have a massive number of parameters, which enables them to capture complex linguistic patterns and generate coherent and contextually relevant text.

A large multi-modal model (LMM) can be thought of as a generalization or evolution of the LLM architecture. Instead of using a single text-based modality, LMMs are designed to handle many different modalities of data. For example, different types of data may be represented with tokens/embedding vectors that may be combined in a high dimensional space.

Ideally, artificial intelligence technologies will provide so-called “foundation model” functionality. Foundation models are artificial intelligence models that are capable of adapting to a variety of data and applications beyond what the models were trained for. In other words, they provide the “foundation” on which other applications may be built.

As a separate tangent, embedded devices are often constrained by their onboard resources; in other words, power consumption, size, performance, etc. are often limited. In some cases, embedded devices may also be real-time devices. Real-time devices are designed to operate and respond to input or events within a specific time frame; the processing and output must occur within a predetermined time constraint to ensure timely and accurate responses.

Artificial intelligence is an exciting new technology, but it poses significant challenges for real-time and/or embedded applications.

### BRIEF DESCRIPTION OF THE DRAWINGS

FIG. 1 is a ladder flow diagram of conventional large language model (LLM) operation.

FIG. 2 presents an example of LLM operation, useful to explain LLM operation.

FIG. 3 presents a typical transformer architecture 300, useful to explain transformer operation.

FIG. 4 is an exemplary ladder flow diagram for user-initiated generative intelligence interactions.

FIG. 5 is a graphical representation of a usage scenario, useful to explain various aspects of the present disclosure.

FIG. 6 is a graphical representation of a foundation model pipeline for real-time embedded devices.

FIG. 7 is a logical block diagram of one exemplary system architecture.

FIG. 8 is a logical block diagram of the exemplary edge device.

FIG. 9 is a logical block diagram of the exemplary aggregator device.

FIG. 10 is a logical block diagram of the exemplary cloud service.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Large Language Models (LLMs), Theory and Operation

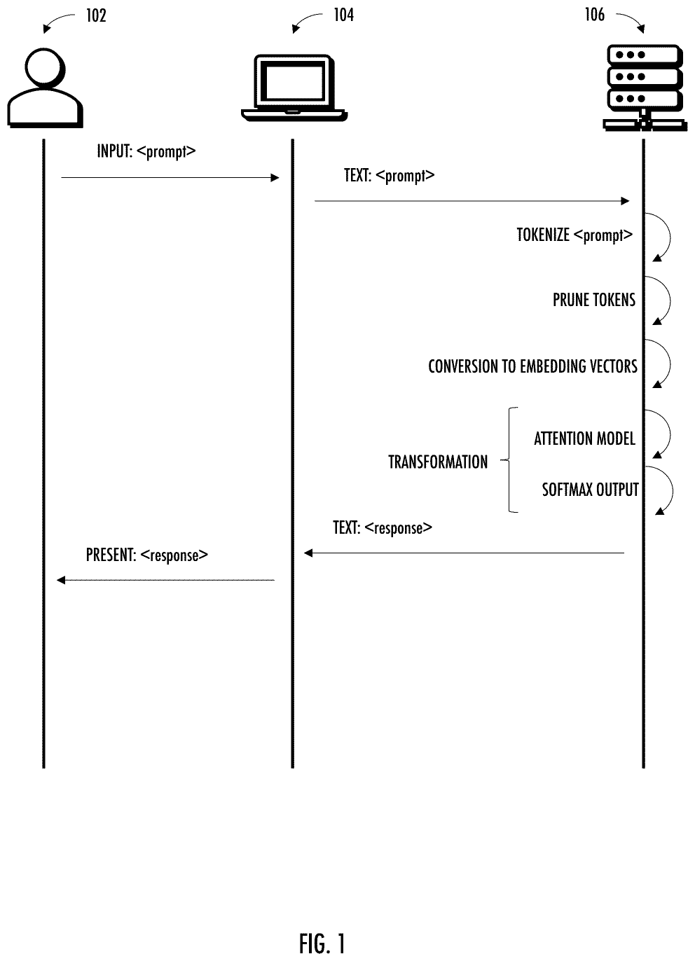

FIG. 1 is a graphical representation of conventional large language model (LLM) operation. As shown, a user 102 provides an input prompt to a client device 104 (e.g., a laptop); for example, a user 102 might type in their prompt, or provide a vocal instruction (the client device 104 may use speech-to-text software to obtain the text prompt). The client device 104 sends the text prompt to the LLM 106. The LLM 106 might perform several distinct steps: tokenization, token pruning, conversion to embedding vectors, and transformation (which includes an attention model for natural language processing and word selection).

The architecture of FIG. 1 operates according to a request-response model, meaning it only processes the data explicitly provided in each interaction. In fact, most conventional request-response LLMs are designed to converse with a user as a chatbot; thus, they emulate a conversational format by design. They frequently check with the user for clarification and/or sufficiency of response—this ensures that the attention model does not ramble away from the user's conversation. In short, the request-response model cannot function independently of the user's input (it lacks its own “agency”).

LLMs are also quite expensive to operate. The cloud-compute infrastructure can support the resource and power needs of an LLM, however, conventional architectures schedule at best-effort and would require modification to access real-time contextual data, such as local sensor inputs, immediate user environment, transient session states, etc. Furthermore, most LLMs maintain some amount of conversation state, but may prune heavy resource utilization and/or sessions that are underutilized due to the expense associated with operation. This results in an unstable and frustrating user experience.

While the illustrative model of FIG. 1 is presented with a specific logical topology, artisans of ordinary skill will readily appreciate that a variety of different physical topologies exist. For example, the functionality of client device 104 might actually be split across multiple devices. Similarly, the functionality of the LLM 106 might be physically localized within a client device 104, etc.

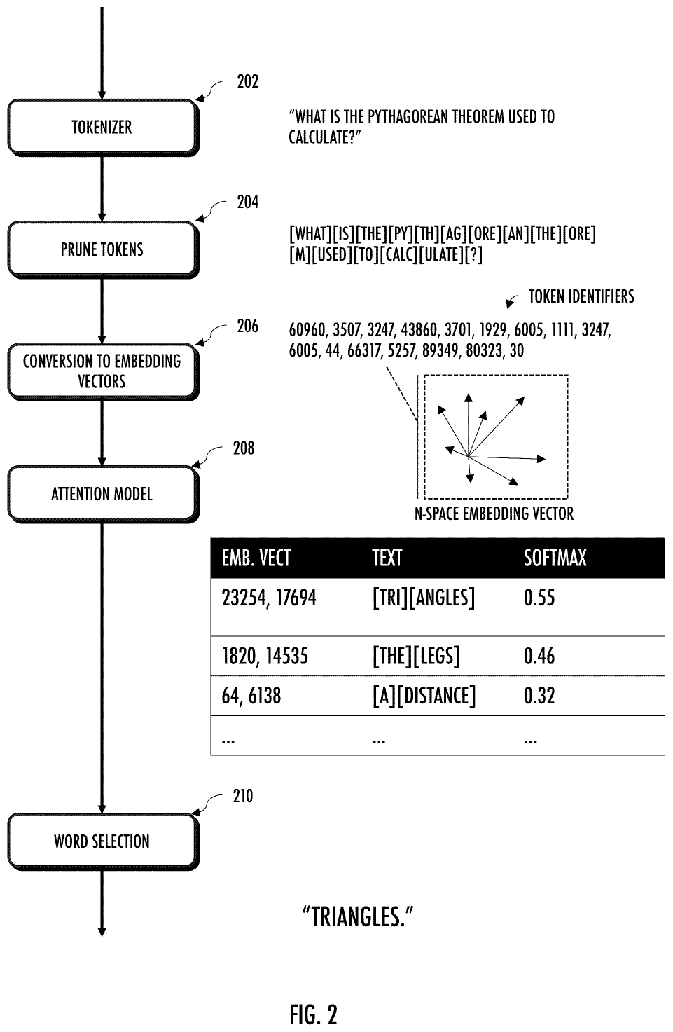

FIG. 2 presents an example of LLM operation, useful to explain LLM operation. At step 202, the input prompt is tokenized. Tokenization is the process of breaking down a sequence of text into smaller units called tokens. Tokens are typically words, sub-words, and even individual characters. For example, a word like “eating” might be represented as two tokens “eat” and “ing”. Tokenization is highly language and context dependent. Empirical evidence suggests that 750 English words corresponds roughly to about 1000 tokens (or about 1 token for every 4 letters). There are special tokens that may have specific meaning to the LLM; for example, many LLMs have “start”, “separator”, “pause”, and “stop” tokens to implement different types of data control within the natural language framework. Importantly, each token is mapped (usually one-hot) to a token identifier (token ID) that uniquely identifies an embedding vector in high dimensional space or control instruction that an LLM has been trained for. For example, an LLM might recognize ˜80,000 unique token identifiers (token IDs).

As a practical matter, conventional LLMs impose a token limit to ensure that computational demands do not exceed the models' capabilities. The token limit is the maximum number of tokens that can be processed by the model to generate a response. Since the LLM maintains a running session state (also referred to as a “context window”), a token limit of e.g., 4096 tokens would correspond to roughly 3000 words of dialogue held in working memory. Notably, both the user's prompts and the model's responses count toward the token limit. If a session exceeds the token limit, then tokens are pruned based on e.g., recency, priority, etc. (step 204).

At step 206, each token is converted to its corresponding embedding vector. In the context of natural language processing (NLP) and machine learning, an “embedding vector” is a numerical representation of a word or a token in a high dimensional vector space. It captures the semantic and syntactic relationships between words, allowing machine learning models to understand and process textual data. For example, an LLM might use embedding vectors with e.g., 384 dimensions.

In slightly more detail, a machine learning model is trained on a large corpus of text data, such as sentences or documents. The model learns to represent each word as a dense vector in a high-dimensional space, where words with similar meanings or contexts are closer to each other in the vector space. In some cases, embedding vectors may additionally be used as part of the training process to customize the machine learning model.

More generally, so-called “foundation models” are artificial intelligence models that are capable of adapting to a variety of data and applications beyond what the models were trained for. In other words, they provide the “foundation” on which other applications may be built. Typically, they're characterized by transfer learning; i.e., the model accumulates internal “knowledge” and applies information from one situation to another. To do this, foundation models must represent data in a manner that facilitates this level of flexibility. For example, within the context of LLMs, words are represented with tokens/embedding vectors in a high dimensional space. In the scientific arts, “high dimensional space” refers to anything higher than physical space (e.g., 3 or 4 dimensions)—for machine learning applications, this is typically tens, hundreds, thousands, etc. of dimensions.

While LLMs are the most widely available foundation model, future implementations will likely incorporate and intertwine other modalities of data. For example, image-based models may use images and/or videos, etc. In some cases, the images and/or video may additionally be embedded with reference to other text, audio, visual, and/or other forms of data. While these large multi-modal models have not yet achieved the maturity that LLMs have, the concepts described throughout may be broadly applied to such implementations as well.

In a related tangent, embedding vectors have several advantages in natural language processing (NLP) tasks. They represent the meaning and context of words as numeric vectors, which enables models to perform arithmetic operations. Addition, subtraction, and dot products (projections) of embedded vectors can be used to find relationships between words. For instance, subtracting a “male” vector from a “son” vector and adding a “female” vector would result in a vector that closely approximates (or identically matches) a “daughter” vector.

Referring back to FIG. 2, an “attention model” takes the array of embedding vectors and generates a number of possible responses at step 208. Transformer models are a type of deep learning first introduced in “Attention is All You Need” by Vaswani et al. in 2017, incorporated by reference in its entirety.

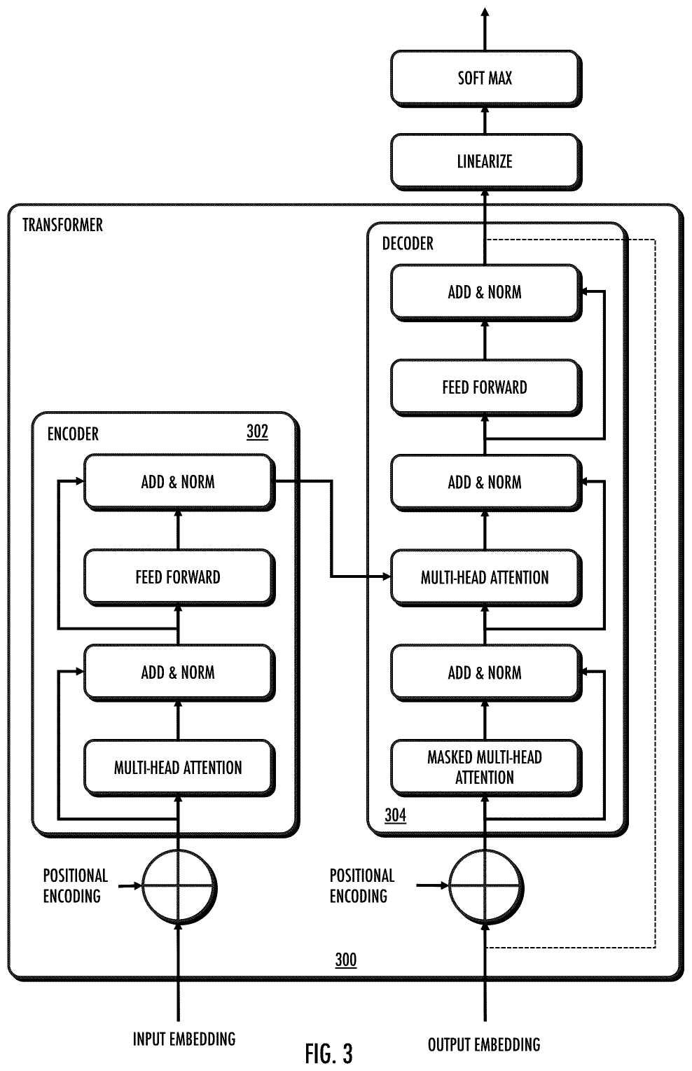

In slightly more detail, FIG. 3 presents a typical transformer architecture 300. The transformer is split into an encoder 302 and a decoder 304. The encoder 302 extracts relevant information from the input prompt, the decoder 304 uses the relevant information to generate possible responses.

Transformer models are based on the concept of “attention”. Certain words have more significance in shaping the context and a meaning in the sentence. Within this context, attention refers to the process of assigning contextual information to tokens (words) in view of the entire sequence of tokens (the sentence). For example, a single attention mechanism might assign 3 vectors to each token: query (Q), key (K), and value (V). These vectors are derived from the embeddings of the tokens. Each token is then given an attention score by taking the dot product of its query (Q) vector with the key (K) vectors of all other tokens. These scores reflect the importance of the token relative to the other tokens. The attention scores are then normalized to different probabilities. These probabilities correspond to the weight that each token's Value (V) vector contributes to the final output. The weighted sum of the Value (V) vectors, based on the probabilities, forms the output for each token. This output represents both local and global contextual information but does not provide enough complexity to mimic human speech.

So-called “multi-head attention” uses multiple single attention mechanisms in parallel to process multiple relationships and patterns within the sequence. Each attention head focuses on different aspects of the input; the results are combined to mimic the linguistic complexity of human speech patterns.

Referring first to the encoder 302, input embedding vectors are first weighted according to positional encoding, which weights each word (token) according to its position in the sentence (input sequence). The resulting vectors are then encoded through multi-head self-attention layer, followed by an “add & normalize” operation which performs layer normalization and adds the original embeddings via a skip connection (also known as a residual or shortcut connection). The result is then provided to a feed forward neural network; typically, a multilayer perceptron of multiple fully connected layers with nonlinear activation functions. The outputs are then added and normalized again before being provided to the decoder 304.

The decoder 304, uses a very similar structure to the encoder 302 (e.g., multi-headed self-attention layer, add & norm, feed-forward, add & norm), however the output of the decoder 304 is fed back through a masked multi-headed self-attention layer and add & norm step. The masked multi-headed self-attention layer masks off portions of the generated target sequence, such that the decoder does not “peak ahead” when predicting the next word. This allows the decoder to generate a target sequence that mimics human speech in both contextual relevance and semantics.

Referring back to FIG. 2, the output of the transformer is a listing of embedding vectors (corresponding text translations shown for illustration) along with a likelihood (e.g., a softmax value). These results are passed through selection logic, which might include additional parameterizations to adjust word selection (step 210). For example, many LLMs incorporate a “temperature” parameter that regulates the unpredictability of a LLM's output. With higher temperature settings, outputs become more creative and less predictable (amplifies the likelihood of less probable tokens), whereas lower temperatures provide less variability (e.g., word repetition, etc.).

Several factors affect LLM complexity. Computational complexity is directly related to the sizes of the feed forward neural networks and the number of heads in the multi-headed self-attention layers-larger models enable more complex sentence structures (both as input and output). As a related consideration, model complexity may also have a token limit. The size of the model may be constrained by the number of tokens that it can simultaneously consider. Token granularity is another factor; each token corresponds to an embedding vector that identifies its relationship to other tokens. Thus, smaller tokens generally correspond to embedding vectors with larger dimensionality. Larger tokens generally correspond to embedding vectors with smaller dimensionality.

### 2 Adaptive Prompt Generation

As a brief aside, so-called “prompt engineering” refers to the practice of designing and refining the prompts used in large language models (LLMs) to elicit desired responses from the model. Currently, prompt engineering has multiple issues. First, most prompt engineering is a manual, iterative, trial-and-error process-a human uses a first prompt, reviews the result, infers what the model might have “understood”, then amends their prompt accordingly. To do this effectively, the user often already has rough expectations of the response they desire. Because of this, most prompt engineering techniques eventually devolve into an exercise of phrasing specific information to the LLM to incorporate within the response. However, certain types of information e.g., Boolean constraints, etc. are more efficiently expressed within existing computer-parsed formats e.g., XML, JSON, or similar logical syntax. In other words, trying to generate natural language prompts to convey this information via attention processing consumes many more tokens than is necessary. Furthermore, natural language also lacks the precision of computer language constructs, thus the same prompt may not have similar results in the same class of models or different models of approximately the same complexity (e.g., computer, parameters), The same prompt may even yield different results in different versions of the same model. While prompt engineering is an interesting exercise, it's not particularly convenient or useful from a user experience standpoint because the process is entirely user-driven.

Embodiments of the present disclosure are directed to agentic prompt generation (machine-generation of prompts). In one embodiment, a user device gathers input regarding a user's prompt and augments the user prompt based on e.g., inferred user intent, sensed data, and/or user information (persona), etc. Importantly, however, the machine-generation of prompts has its own agency (rather than responding to the user without any agency of its own). In other words, agentic machine-generated prompt augmentation operates independent of the user-generated prompts. For example, machine-generated prompt augmentation may adaptively select the amount of and/or type of prompt augmentation. While the following example is presented in the context of a user wearing smart glasses in communication with a smart phone, the concepts may be broadly extended to a variety of user devices (smart watches, laptops, smart jewelry, and/or any other user device in the mobile ecosystem).

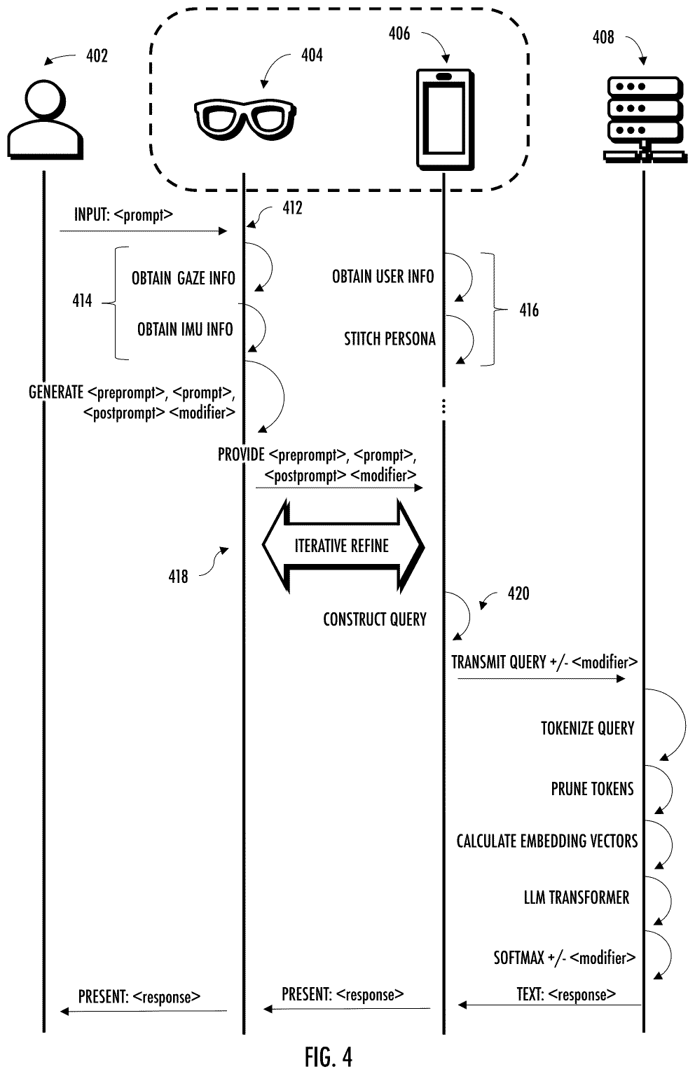

FIG. 4 depicts a ladder flow diagram of one implementation. As shown, a user 402 has a set of user devices (e.g., smart glasses 404 and/or a smart phone 406). These components may be in stateful, or state-less, communication with a 3rd party large language model (LLM) 408. As shown, the user interacts with a system that is “pipelined” into multiple different stages: capture devices, LLM input specializers, query constructors, and one or more processing resources which may include foundation models, internet resources, and/or other user devices/databases.

During online operation, the user devices collect information about the user's activity and intent. For example, the smart glasses 404 may incorporate a microphone to capture sound (including user speech), inward-facing cameras to monitor user gaze, “always-on” cameras to monitor the external environment (at low resolution (e.g., 1080p), low frame rates (e.g., 30 fps), etc. to save power), outward-facing cameras to capture the user's forward view (at high resolution (e.g., 4K), high frame rates (e.g., 60 fps) for image processing, etc.), and/or global positioning system (GPS) and inertial measurement units (IMU) to provide location and/or movement data. Similarly, the smart phone 406 has access to internet activity, communications, and receives captured images, sounds, and location/movement data from the smart glasses 404. This information may be “stitched” together offline to create a large database of persona information. For both privacy and complexity reasons, the 3rd party large language model (LLM) 408 may not have unlimited access to the persona information.

As used herein, the term “online” and its linguistic derivatives refers to processes that are in-use or ready-for-use by the end user. Most online applications are subject to operational constraints (e.g., real-time or near real-time scheduling, resource utilization, etc.). In contrast, “offline” and its linguistic derivatives refers to processes that are performed outside of end use applications. For example, within the context of the present disclosure, user prompt augmentation is performed online whereas stitching a persona may be performed offline.

As used herein, the term “real-time” refers to tasks that must be performed within definitive time constraints; for example, smart glasses may capture each frame of video at a specific rate of capture. As used herein, the term “near real-time” refers to tasks that must be performed within definitive time constraints once started; for example, smart glasses may perform object detection on each frame of video at its specific rate of capture, however some variable queueing time may be allotted for buffering. As used herein, “best effort” refers to tasks that can be handled with variable bit rates and/or latency.

As shown in FIG. 4, the user 402 creates a prompt. In this example, the user asks a question verbally. At step 412, the smart glasses 404 may capture the waveform locally and convert the speech to text to create a text prompt. More generally, however, any number of different user inputs may be used to create a prompt. In some embodiments, a user may have “canned” prompts based on gestures or other user interactions. As but one such example, a user may fix their gaze on a milk carton in a store, the smart glasses 404 may interpret the gaze fixation in view of the location (store) and target (milk), to be phrased as a question: “Do I need to buy more milk?” A device may have a number of default canned prompts and/or may allow the user to add more e.g., via manual input and/or learned through a history of interactions.

To further clarify, user prompts may be verbal, non-verbal, gestures, and/or other user interaction. For instance, in the foregoing scenario, the user's smart glasses may use gaze point in combination with a timer to select a “canned” prompt based on the user's contextual clues (e.g., walking around a grocery store). Here, the contextual clues can be used to infer a “user story” e.g., the user is doing grocery shopping and trying to determine whether they have that item already. In this case, the system may use an LLM to interpret the user story, find and process the relevant data (e.g., check the user's food at home), and generate the appropriate response. In other words, the user prompt may be wholly device-generated depending on context.

At step 414, the smart glasses 404 gather contextual information about the user, their environment, and/or objects of interest, that may be useful to augment the user prompt. As but one such example, smart glasses 404 may use inward-facing cameras and/or outward-facing cameras to obtain gaze information, and/or other data (e.g., location and/or movement data). In some variants, this may be performed according to a static procedure (regardless of the prompt). In other variants, the information may be selectively gathered depending on the prompt; for example, a person that asks “Who is that?” might trigger a facial detection process at or near the user's gaze point, similarly a person that asks “What is this?” might trigger an object detection process at or near the user's gaze point, etc.

In some cases, the smart glasses may have on-device captioning logic which implements image-to-text functionality. The captioning logic may take an input image and generate one or more labels. In some cases, the labels may be text; in other implementations, the labels may be tokens and/or embedding vectors (discussed in greater detail below). In some cases, the captioning logic may also identify certain characteristics of the image (e.g., indoors/outdoors, near/far, etc.). More generally, the image-to-text functionality may broadly encompass any logic configured to generate text data from image data; this may include e.g., optical character recognition and/or other forms of image analysis logic.

At step 416, the smart glasses 404 augment the prompt based on the contextual information. As a brief aside, LLMs widely vary in capabilities and function. While it is true that larger (and more expensive) models generally outperform smaller (less expensive models), there are many other important considerations. Some LLMs may have access to topical knowledge (e.g., LLMs that have been trained for specific topics or tasks)—these LLMs do far better in their narrowed field (e.g., medical, scientific, etc.), but are not suitable for general use. Other LLMs may have fast response times, larger token limits, handle complicated grammatical structures, etc. In some cases, an LLM may not even be the ideal source of information e.g., a user may just want the direct internet resource or local search result. In other words, selecting the correct LM or other resource may be a critical decision. For example, a research scientist user may use a topically-specific LLM to assist in answering quick questions, yet that same user might “change hats” and need to do grocery shopping after work, a task better suited for a different general-purpose LLM. A work-related prompt does not need ancillary information about the user's dietary preferences, and vice versa. Here, the smart glasses 404 have ample opportunity to improve the user experience.

In one embodiment, the smart glasses 404 include one or more large language model (LLM) input specializers. Functionally, an LLM input specializer augments the user's prompt in view of captured data and/or personalization data (“persona”). In one specific implementation, the LLM input specializer maintains a map of different prompt augmentations (pre-prompts, mid-prompts, post-prompts) for different types of questions.

In one specific implementation, image-to-text and/or speech-to-text processes the input data to generate labels. Mapping logic maps the labels various classification areas. For example, a person looking at a menu (and/or asking about a menu item) would be mapped to the general category of food, etc. Here, the LLM input specializer may provide prompt augmentation based on a set of previously stored food-related prompt augmentations.

While the foregoing example uses machine generated labels for prompt augmentation, other types of augmentation may be based on key words or key phrases. For example, the LLM input specializer may have a list of specific words or phrases that are commonly used (generic or user-specific) together with a variety of different locations, activities, etc. Such keywords may include e.g.: “who”, “what”, “where”, “when”, “how”, etc.; key phrases might include e.g., “what can I do . . . ”, “what is . . . ”, “how much is . . . ”, “where did I . . . ”, etc. In other words, if speech-to-text translation of the user's prompt includes “what is . . . ” then a first set of pre-prompts are mapped, if the prompt includes “how much is . . . ” then a different set of pre-prompts may be mapped.

More generally, the term “map” and its linguistic derivatives refer to any logic that associates labels (e.g., inferred from user intent) to a set of elements (here, predefined prompt augmentations). While the foregoing examples are presented in the context of simple mappings, the concepts are broadly applicable to any association (including one-to-one, one-to-many, many-to-one, many-to-many, etc.). Additionally, while the foregoing example is presented in the context of a one-to-one look-up, more complex variants may use e.g., a reduced-complexity LLM or other text analysis logic to provide more complex associations.

In some cases, the LLM input specializer may also consider LLM-specific factors such as e.g., availability, latency, cost, etc. when augmenting the prompt. While the LLM input specializer may not directly launch the query (this may be performed by a query constructor described in greater detail below), the LLM input specializer may use LLM-specific information to change the amount of information and/or type of information provided to a query constructor. Furthermore, some variants may also allow the LLM input specializer to recommend a destination LLM to the query constructor. For example, an LLM input specializer may recognize the environment as a work environment and recommend a work-specific LLM (or otherwise topically-specific LLM). As another example, an LLM input specializer may recognize that the user appears to be referring to their own property (e.g., “where are my keys?”, etc.) and may infer that the prompt should be directed to the user-specific database. Still other user prompts may be qualitatively or quantitatively assessed for complexity; more complex prompts may require more sophisticated LLMs, simpler prompts may be more quickly (and inexpensively handled) with simple LLMs.

While the present discussion is described in the context of a single LLM input specializer, various implementations may use multiple LLM input specializers to further subdivide prompt augmentation. As but one such example, the smart glasses 404 may include a first LLM input specializer that augments prompts based on its captured data, whereas the smart phone 406 may have a second LLM input specializer that augments the prompt in view of persona data (described below). In some embodiments, multiple LLM input specializers may be parallelized and/or serialized. Parallelized processing may be important for reducing latency of multiple independent processing tasks; for example, where a user prompt may touch on multiple distinct topical areas or specialties (these data are unrelated and separate). Serialized processing may be useful for dependent tasks (e.g., topically, sequentially, and/or conditionally related). For example, a user may ask for suitable restaurants nearby (e.g., place/time information is dependent on personalization information). As another example, a user may ask for information about a specific hole on a golf course (e.g., both generalized information as well as user-specific notes from previous play (if any)).

As another important note, words/tokens and sensed data have significant differences in size. A large amount of sensed data may be condensed into only a few tokens; thus, LLM input specialization that occurs at the smart glasses 404 can greatly reduce the amount of data that needs to be sent to the smart phone 406. This directly corresponds to reduced processing, encoding, memory and power consumption on both devices, as well as any downstream processing. While the foregoing embodiments are discussed in the context of “words” and “text”, the concepts may be broadly extended to any user device that can capture data from its environment (e.g., images, sounds, symbols, gestures and other user interactions, etc.) and convert the data into tokens or other data structures natively used within a machine learning foundation model.

Furthermore, input specialization may be useful in a variety of other contexts. In other words, while LLM input specializers are designed to augment prompts with additional information in a natural language format, the mapping/association techniques described above can be readily adapted to other destination types. For example, a website input specializer may be used to map speech-to-text, images, and/or image-to-text over into generic website specific inputs and/or navigation. Similarly, a social network input specializer may be used to map speech-to-text, images, and/or image-to-text over to social network-based interactions.

### 2.1 Pre-Prompts, Mid-Prompts, and Post-Prompts

As used herein, the term “prompt” refers to a user generated input for a large language model. For language-based prompts, the prompt is spoken in a natural language format. In other words, the LLM processes the prompt according to an attention model (e.g., encoder and decoder). As used herein, the term “pre-prompt”, “mid-prompt”, and “post-prompt” refer machine generated text that is added before, within, and/or after, the prompt before processing for the LLM. Importantly, the machine generated pre-prompt, mid-prompt, and/or post-prompt may use the natural language input format but need not have the full flexibility of an LLM.

Consider the following scenario, a user wearing smart glasses is shopping at a grocery store. They are casually picking up items, inspecting them, and adding them to their cart, or putting them back on the shelf. The smart glasses maintain a list of only items that are carted, along with the current item being inspected. The user conversationally asks, “I already have chicken, what can I do with this ingredient?”

While this prompt could be provided to an LLM “as-is”, the LLM cannot provide a meaningful response since it does not know what “this ingredient” is in reference to. However, the smart glasses have captured an image of an object that the user is inspecting. In addition, gaze information may be used to identify that the held object is being referred to as “this ingredient.” Image-to-text processing may identify the held items as a pound of ground beef. Based on this information, the smart glasses may generate a simple pre-prompt: “I am holding a pound of ground beef.”

As previously discussed, certain key phrases may also trigger prompt augmentation. In this case, the key phrase “what can I do” is mapped to recipe look-ups at the grocery store-which are improved by the user's current list of kept items. So, the smart glasses may refer back to the list of objects that have been kept in the cart: a carrot, an onion, and a bell pepper. Thus, the smart glasses may generate a simple post-prompt to convey the user's current inventory: “I also currently have a carrot, an onion, and a bell pepper.”

Finally, this particular linguistic combination may have ambiguous meaning. Did the user intend to use both the chicken and the ground beef, or did the user intend to replace the chicken with the ground beef? In this case, the user devices (smart glasses and/or smart phone) may determine that the user's reference to chicken does not refer to an item in their cart and that the user's refrigerator has nearly expired chicken breasts. By inference, the smart glasses may disambiguate this linguistic structure to mean beef instead of chicken. Thus, the smart glasses 404 may insert a mid-prompt “but I don't want to use it”.

In summary, the complete prompt with pre-prompt, mid-prompt, and post-prompt augmentations might be: “I am holding a pound of ground beef. I already have chicken, but I don't want to use it, what can I do with this ingredient? I also currently have a carrot, an onion, and a bell pepper.” Prompt augmentation in this manner may provide contextually useful information within the natural language format.

### 2.2 Query Modifiers

In addition to natural language prompt augmentation, there may be other operations that do not require natural language processing. For example, smart glasses might add +grill to a user's spoken input “what can I cook today?” if they are looking at a grill, or +oven if they are looking at an oven. As used herein, the term “modifier” refers to data (which may or may not be text) that is not processed as natural language. In some implementations, modifiers are directly handled in the attention model (e.g., as an additional embedding vector, etc.), in other implementations, the modifiers may be handled outside the attention model (e.g., used during softmax selection, etc.). Modifiers may be useful for processing that can be performed prior-to, or subsequent-to, natural language processing. One such example could be Boolean logic, filters, softmax operations, etc.

In one embodiment, modifiers are used by the LLM input specializer to communicate explicit data constraints to other entities (e.g., query constructor, 3rd party LLMs, internet resources, etc.). Here, the LLM input specializer may use modifiers to impose specific prompt augmentation limitations, outside the natural language format. Examples might include search modifiers (e.g., time, location, distance, +words, −words, etc.) which indicate to the query constructor that the response must e.g. fall within a specific time range, at a specific location or within a distance of the location, include certain words, and/or exclude certain words, etc.

Consider a sightseeing scenario where a user wearing smart glasses asks: “What's nearby?” Here, in addition to prompt augmentations, the smart glasses may use location data and/or IMU data to determine if the user is walking or driving, etc. This information may be used to select a distance modifier. The distance modifier may be used to filter LLM responses according to a “capped” distance (e.g., a maximum distance of 1 mile for pedestrians or 10 miles for motorists, etc.).

As but another example, a group of users with a set of smart phones may enter a restaurant for lunch. The different members may have different diet restrictions (“vegan”, “peanut allergy”, etc.) of varying importance. One of the users may ask, “What do you recommend for us?” Here, the LLM may retrieve a set of menu suggestions which are then filtered based on the modifiers. For example, the LLM response may be checked to ensure that at least one dish that is suggested includes a vegan dish (but may not necessarily require that all dishes are vegan). In addition, the LLM response may be modified to remove any peanut dishes (to avoid cross contamination).

While modifiers may not have the same flexibility as natural language, modifiers do not require interpretation within an attention model. Consequently, modifiers are supported on a much more diverse array of resources. For example, modifiers may be inserted by non-LLM components in the pipeline; image-to-text and/or speech-to-text pre-processing may be used to generate captions that are added as modifiers for inputs to the LLM. Similarly, modifiers may be used post-LLM to constrain other entities. For example, a +word modifier is understood by search engines to mean that the search result must include the +word; this can be interpreted identically within LLMs even if the implementation is different (e.g., filtering of softmax selection, etc.). In other words, modifiers may be shared with consistent interpretation across the entire system pipeline.

### 2.3 Persona-Based Prompt Augmentation and Stitching

As a separate tangent, the smart phone 406 periodically “stitches” user data into a “persona” (step 416); the persona may be further used to further refine prompt augmentation. Conceptually, while smart glasses 404 have direct access to immediate physical data, the smart phone 406 is the repository of the user's virtual activity (e.g., social networks, purchases, email, texts, calls, etc.) and may also archive particularly salient information from the user's day (region-of-interest snapshots, voice commands, etc.). Thus, the smart phone 406 can accumulate information that defines the characteristic traits of a user. Furthermore, the smart phone 406 has more computational power, fewer thermal restrictions, and significant time for background processing, compared to smart glasses 404—this may be particularly important for computationally intensive stitching discussed below.

While the following discussion is presented in the context of a smart phone “stitcher”, any device with sufficient resources may be substituted with equal success. For example, stitching could be performed via cloud compute, server, personal computer, laptop, etc. Furthermore, artisans of ordinary skill in the related arts will readily appreciate that technology continues to improve such that future technologies may perform stitching in form factors that are currently infeasible (e.g., smart watch, smart glasses, etc.).

As used herein, the term “persona” refers to a body of history-based user-specific information that enables the machine-generated prompt augmentation, LLM-selection, and/or other modifications of the control and/or data path for natural language processing. Persona information is not based on the user's words, gaze, or other sensed environment, but is retrieved from e.g., a user-specific database, cloud archival, etc. In one embodiment, the persona data structure maps user-specific relationships between tokens/embedding vectors of the foundation model. Persona dynamically changes as newly observed data points constructively/destructively reinforce previously identified relationships. New relationships may also be created from observed patterns of behavior.

Persona may be used to vary responses in many different ways. Different people asking the same prompt may receive different results due to differences in their personas. For example, a cinephile that asks for movie recommendations should receive more targeted recommendations for their tastes and also may prefer a richer set of information about the movies in comparison to a casual filmgoer. In some cases, the same user may want to receive different responses for similar queries, based on different contextual environments/times, etc. For instance, a user that asks for restaurant suggestions at work (e.g., convenience, networking opportunities, etc.) may have a different purpose than suggestions at home (e.g., healthy, kid-friendly, etc.). Still further, a person focusing their intent on different items of interest (targets) should receive different responses based on their relationship to those objects. For instance, a user's questions about a brand-new car (versus their owned car) are likely to be quite different.

In one specific embodiment, persona information may be cumulatively updated with user activity. Initially, persona might include basic personal information e.g., name, age, gender, home address, work address, schedule, social connections, and their corresponding details (e.g., family, friends, co-workers, etc.); this may be provided directly by the user via an intake questionnaire and/or scraped from existing data, calendars, and/or social media, etc.

Over time, the user's smart glasses accumulate a broad spectrum of data during day-to-day activities (e.g., images captured over time, region-of-interest and gaze mapping information, vocal prompts, etc.). In addition to smart glasses data, the smart phone may also record daily travel, patterns of use, current interests, social networking activity, communications, etc. The physical and virtual activity of the user is then “stitched” into the persona information. In some cases, persona information may also be manually added to, removed from, and/or otherwise edited by the user (if desired) so as to further improve user experience.

As used herein, the term “stitching” (or “dreaming”) and their linguistic derivatives refers to the process of creating new relationships (and/or fitting existing relationships) to newly observed data within the high dimensional space of a foundation model framework. This enables high dimensional connections within the foundation model framework beyond the newly observed data points. For example, consider a person that regularly commutes between 8 AM-9 AM and 5 PM-6 PM; these time ranges may be labeled as “commute”. Labeling in the natural language format inherits the full descriptive richness of the tokens/embedding vectors of the foundation model; e.g., the tokens/embedding vectors for “commute” are additionally related to “work”, “keys”, “car”, etc. in high dimensional space. Thus, for example, “where did I use my keys last?” could result in the response “you used your keys for your commute.”

Stitching enables user-specific associations that extend beyond generic associations that may exist in trained data sets. For example, consider a specific person that regularly visits a specific store and where the specific person may also have a preferred beverage. A generically trained model might learn that the specific store sells many types of beverages, however any association between the specific store and any beverage would be relatively small. Stitching algorithms may use transitive relationships (e.g., if a first user context is associated with a second user context and the second user context is associated with a third user context, then the first user context may also be associated with the third user context) to infer the user-specific linkage between the specific store and the preferred beverage. Other examples of relationships that may be substituted with equal success may include commutative, associative, distributive, identity, inverse, and/or any other logical relationship. For example, a commutative relationship might infer that if a first user context is associated with a second user context, then the second user context is also associated with the first user context. Here, stitching seeks to create, remove, attenuate, and/or amplify relationships between embedding vectors in higher order space based on user-specific observations. Functionally, stitching seeks to identify patterns of behavior from observed user activity that can be extended to real-time predictive associations (e.g., trigger conditions and responses/reactions).

In one specific variant, accumulated data from the smart glasses and/or smart phone is periodically stitched to identify temporal, spatial, and/or activity patterns of the user across the day. When compared across days, the stitching may establish patterns of a user's daily routine. The daily patterns and/or routines may be described in text and converted to tokens. Importantly, certain salient user interactions (e.g., gaze point information and/or user generated prompts) and/or machine responses are already converted to tokens as a part of the LLM query-response interaction—these transactions may be stitched “as-is” from cached history data.

As but one such example, the stitching process may include pattern recognition over the previously used tokens/embedding vectors accumulated throughout the user's day-to-day activities. For example, image-to-text may be used to convert images into labels; these labels are then converted to tokens/embedding vector, etc. Similarly, labels and tokens/embedding vectors from vocal instructions and other forms of activity data (e.g., calendar data, physical location history, browsing history, health, and activity monitoring data, etc.) may be collected. These label data and tokens/embedding vectors are then correlated between each other to identify repetitive user patterns based on time, location, activity, etc. The resulting candidate matches are used to reinforce the existing associations (if any) in the user's persona, or to create new associations.

For example, consider a user that likes to hear news articles during their commute. Initially, they ask for news articles during their commute, and repeat this pattern over a few days. This pattern is captured as a user-specific routine. Later, during offline stitching, the “commute” label for this user may be associated with the user's news article preferences, etc. As a result, future queries may detect that the user is about to start their commute, and pre-emptively download suitable news articles. Importantly, this connection (which likely did not exist before) is inferred from user-specific patterns in high dimensional space—e.g., “commute” and “news” are typically not linguistically related. Different user's might use their commute time differently e.g., to check email, plan their to-do list, shop for clothes, play games, etc. In other words, this is a personalization learned through observed user activities (not searched for among sets of archetypes).

There are conventional technologies that already mine user data for data connections, however many of these techniques are focused on fitting the user according to a predefined set of criteria or a predefined tranche of similar users (e.g., mining user data to provide advertising relevancy, etc.). While this provides the most straightforward and efficient mapping of a user against known archetypes (such as marketing demographics), it is intractable for arbitrary connections between all possible words. In other words, these techniques require searching against a known search space; larger search spaces result in exponentially growing complexity.

In contrast, the discussed techniques grow user-specific associations from observed data points, according to the embedding vectors of the high dimensional space. Connections are observed as they occur and stitched as a background process; this does not require a “search” process. This technique for stitching new relationships into an existing high dimensional space is much more tractable for consumer electronics.

In one specific implementation, the strength of association may be based on repetition. For example, associations may be recently adopted, short term, long term, habitual, etc. Habitual associations may be the most strongly weighted. In some cases, the user may have the ability to reset some or all of their identified associations. This may be particularly useful where a change drastically affects previously established behavior. For example, moving to a new home might change a previously habitual commute pattern; a hard reset allows the user to re-establish a new commute pattern without being bothered by irrelevant old commute patterns. More generally, however, strength of association may be based on a variety of factors e.g., emotional state, social reinforcement, user preference, device considerations, etc.

While the present disclosure is discussed in the context of a single persona for a user, the various techniques could be broadly extended to multiple personas for a single person. For example, a person might want to separate their work persona from their home persona, etc. Such a division may be useful to explicitly silo certain types of user activities and/or preferences, etc. Furthermore, while the following discussion is presented in the context of a single user, the concepts may be broadly applied to groups of users. For example, friends at a restaurant ordering multiple dishes to share might create a group persona that reflects the aggregated preferences of the friends as a whole.

### 2.4 Iterative Refinements and Query Construction

As previously alluded to the LLM input specializer augments the user's prompt based on captured data and/or persona, this information is provided to the query constructor to generate the actual query. Functionally, the query constructor manages the control path and data path of the overall system pipeline for queries. In the system pipeline of FIG. 4, the LLM input specializer(s) may capture the user generated prompt and provide suggested prompt augmentations; however, the query constructor may additionally determine that more information is needed, and iteratively refine prompt augmentation (step 418).

While the foregoing discussions are presented in the context of a single query that is constructed from a single user input for ease of illustration, query construction is not necessarily 1:1—any M:N mapping may be substituted with equal success. For example, complex user input may be sub-divided into multiple queries. Similarly, simple user input may be aggregated and/or combined with other user input. Here, the simplicity and/or complexity of the user input may be determined via length, subject matter, grammatical construction, multi-modality (verbal and image processing, etc.) and/or any other characteristic of the user input.

Within this context, the “control path” refers to the logic responsible for directing and coordinating the operations of the pipelined system. The control path generates the control signaling that determines the sequence of operations performed by the pipeline. In contrast, the “data path” refers to the logic responsible for manipulation and processing of data within the system. The data path performs tasks such as encoding/decoding to high dimensional space, high dimensional space operations, etc.

In one embodiment, a query constructor executing on the smart phone may receive a first set of capture-based prompt augmentations from a first LLM input specializer on the smart glasses and a second set of persona-based prompt augmentations from a second LLM input specializer on the smart phone. In this case, the first LLM input specializer may access a first layer of image-to-text that is reduced in size and/or complexity to operate within the design constraints of the smart glasses. The second LLM input specializer running on the smart phone has access to the user's persona data and may have more generous design constraints (more powerful processor, larger memory, higher thermal dissipation, etc.). Additionally, a second more capable layer of image-to-text may be run on e.g., the smart glasses (or smart phone) when requested, to provide more detailed labeling of the image.

Consider a user holding a bottle of soda pop; the first layer of image-to-text may identify the object as “soda”. Initially, this text label may be provided to the smart phone with the prompt augmentations from the capture-based prompt augmentations. While “soda” might be sufficient for a generic query, in this case, the user's persona may include preferred and/or non-preferred types of soda. For example, the persona-based LLM input specializer would have different associations if the “soda” is “Diet Cola” (preferred) versus “Root Beer” (non-preferred). Here, the persona-based LLM input specializer may instruct the second layer of image-to-text to disambiguate the bottle of soda. In one variant, the second layer of image-to-text is executed on the smart glasses, and the updated labels are provided to the smart phone. In other variants, the smart glasses provide the captured region-of-interest image data to the smart phone, and the second layer of image-to-text is executed from the smart phone. In still other variants, the smart phone may forward the region-of-interest to an external 3rd party server for further analysis.

Multiple iterations may be used to refine information to virtually any arbitrary degree. For example, a “musical instrument” might be disambiguated into “guitar” in a first iteration. In a second iteration, the “guitar” might be classified as a “electric” or “acoustic”. In a third iteration, the acoustic guitar might be classified as a “6-string” or a “12-string”. In a fourth iteration, a picture of the 12-string acoustic guitar might be classified into brand and/or model information (e.g., Martin D12-28, etc.). Iterative refinement in this manner allows for sequentially more constrained classification tasks which can be performed only to the extent needed (rather than one monolithic classification task performed to completion).

In some cases, cached information may be retrieved and/or new information may be captured across multiple iterations (e.g., additional image captures and/or request clarifying input from the user, etc.). For example, the smart glasses might attempt to perform image-to-text but determine that a new capture is needed (better lighting conditions, etc.). As a related example, an LLM input specializer may determine that additional information is needed from the user; the user may be asked to clarify the prompt.

While the foregoing discussions are presented in the context of image-to-text and speech-to-text, virtually any classification and/or recognition logic may be used in combination with the foregoing. For example, some implementations may use e.g., optical character recognition (OCR) and/or reverse brand image search, etc.

Once the query constructor has sufficiently refined the prompt, the query constructor takes the user generated prompt and the machine generated prompt augmentations (if any) and constructs a query (step 420). Specifically, in one implementation, the query constructor selects the destination resource based on the prompt itself (and prompt augmentation, if any), labels from image-to-text, labels from speech-to-text, and/or the type of query (mapping from the LLM input specializer).

As used herein, the term “query” and its linguistic derivatives refers to the message that is sent to the destination resource. In some embodiments, the query could be provided in terms of text and/or words (e.g., the user's prompt along with any pre-prompt, mid-prompt, post-prompt, and/or modifiers, etc.). In such implementations, the destination would tokenize the query. However, in other embodiments, the query may be transmitted in the form of tokens/embedding vectors and/or other data structures natively used within a machine learning foundation model. In other words, the destination resource may directly process the query within its high dimensional space.

In one embodiment, the query constructor may select from multiple different destination resources. As previously noted, different LLMs are trained differently and/or may have differences in implementation, available resources, security, privacy, and/or any number of other differentiating characteristics. Thus, the query constructor may select destination LLMs (or other resources) based on any such considerations.

In one specific implementation, the query constructor uses LLM-like logical components to perform destination selection. Much like an LLM, the query constructor may include an encoder that accepts text or token-based input. The results are fed to a decoder; however, the decoder is not trained to provide text output; instead, the decoder provides softmax values for different destination resources. In other words, rather than trying to predict the next word in the sentence, the query constructor attempts to predict the resource that is able to answer the query. Since most implementations will only select between a few candidate destinations (rather than a full lexicon of spoken language), destination selection can be performed on the smart phone using minimal multi-head attention model and soft max selection logic.

A softmax score above a cut-off threshold indicates that a resource is suitable. A so-called “indeterminate” selection occurs where no destination exceeds the minimum cut-off threshold. In other words, more information may be needed in order to identify a suitable resource. In some cases, indeterminate values may trigger iterative prompt refinement (discussed above)—the user may be asked to clarify their request, additional information may be retrieved from the user device, etc. In some implementations, a default destination resource may be used for indeterminate values; this may be useful where a user may want to send a request for a fast response (e.g., relying on the downstream LLM to resolve the ambiguities).

A so-called “ambivalent” selection occurs where multiple destinations exceed the minimum cut-off threshold. In some variants, the query constructor may select the highest scoring resource for the destination resource. In other variants, the query constructor may launch multiple requests sequentially or simultaneously (as discussed in greater detail below). In still other variants, the query constructor may further constrain the results with iterative refinement until a single resource is identified.

While the query constructor is described as an LLM-like logic that can process words/tokens to identify the destination resource, virtually any scoring and/or decision logic configured to select a destination resource based on a user generated prompt, machine generated prompt augmentations, and/or accumulated personalization data may be substituted with equal success. In some embodiments, the scoring and/or decision logic determines the relative complexity of the desired query (e.g., whether a search is easy or hard, etc.); the query may be modified to fit the destination, or the destination may be changed based on the query complexity. As another such example, the scoring and/or decision logic may consider whether the information is user-specific (or local) or generalized. User specific queries (e.g., “Where are my keys”) may be transmitted to a user-specific database for processing whereas generalized queries may be directed to other internet resources. Still other implementations may use topical information to determine whether the query should go to a topically-specific LLM or a general-purpose LLM. Here, topically-specific queries may be recognized through the usage of topically-relevant tokens; in other words, some LLMs recognize unique tokens (and/or combinations of tokens) that other LLMs do not.

While the foregoing discussion is presented in the context of text-based queries, the concepts may be broadly applied to future large multi-modal models. For example, such implementations may allow the query constructor to directly access region-of-interest (ROI) data and/or comprehensive image data; this may be important where the large multi-modal model may operate on image data. Similarly, other implementations may allow the query constructor to directly access recorded audio waveforms, location and/or IMU data, etc.

Furthermore, the query constructor may receive a large number of potential prompt augmentations based on e.g., captured images, user instructions, and persona data-however, these suggestions may have been based on partial information and/or may have been made without knowledge of the destination resource. While iterative refinement may be used to obtain more information, the query constructor may also need to prune away redundant/unnecessary information. Thus, once the destination resource(s) are selected, the query constructor may prune unnecessary portions of the query which do not appear to affect the desired response. Prompt augmentations that appear to significantly overlap other prompt augmentations may be removed in whole, or combined together, to remove redundant portions. For example, a capture-based pre-prompt might be: “I am holding spinach” and a personality-based pre-prompt might be: “I am vegetarian”—while the vegetarian information might be useful in some contexts, within this specific context it may be redundant and can be removed.

As a related consideration, the positional encoding varies across LLM implementations. In other words, different LLMs may weight the information of various portions of a query differently. Thus, the query constructor may modify prompt augmentation in view of the positional encoding of the destination LLM. For example, consider a destination LLM that prioritizes information at the start and end of a query over information in the middle. While the LLM input specializers may conservatively provide multiple options for positionally encoding a specific piece of information (a pre-prompt, mid-prompt, and post-prompt), the query constructor may only include the option that corresponds to the importance of the information. Here, important information might be placed in a pre-prompt, background information might be provided in the mid-prompt, etc.

Embodiments of the query constructor may separately store the state of the user's conversation. Here, the conversation state is locally stored and distinct from the destination LLM's session state (or context window); in other words, the conversation state may persist over many conversations and/or may have much larger (potentially limitless) token limits. Conversation state can be used to refresh and/or re-initiate a conversation with a destination LLM such that the conversation remains coherent to the user. When the token limit for the destination LLM is exceeded, the query constructor may selectively include or even re-insert prompt augmentations which ensure that the relevant tokens are present.

Furthermore, sometimes the LLM session state may time-out from disuse. Here, the query constructor can resurrect the previous LLM session state by pre-emptively sending a pre-prompts to establish critical details that the user is interested in. Consider, for example, a user that asked “What can I cook with this ingredient?” at the grocery store. They bought the ingredient and returned home. In the intervening time, their previous LLM session may have timed out. Here, the query constructor may reconstruct the previous conversation, so that when the user asks, “can I add this spice to the recipe?” the question is answered in the context of the same recipe that they were shown at the grocery store.

Decoupling conversational state from session state allows a LLM to seamlessly pick up a conversation, either from a previous conversation, or in some cases, from another LLM. In one specific implementation, the query constructor may independently track the user's conversational state. In simple implementations, this may be a stored text record of a running dialogue between the user and the glasses; the dialogue may then be used to generate prompt augmentations to bring the LLM up to the current conversational state. Some LLMs may directly expose session state (or context window) information via an API (application programming interface) or similar communication protocol; in such implementations, the query constructor may request session state and/or prime the session state via the API.

While the foregoing discussion is described in the context of a user-initiated process, the concepts may be broadly extended to machine-initiated processes as well. As but one such example, the query constructor may pre-emptively launch LLM queries based on image-to-text (or speech-to-text, IMU, etc.) input that is captured from the smart glasses. This may be useful to keep the query constructor up to date on the user's environment, activities, etc. Consider, for example, a smart phone that is tracking the user's location in the background during their day-to-day activities; when a user appears to be in an important location (e.g., based on persona data, etc.), the query constructor may pre-emptively trigger an image capture of the user's gaze point and send LLM queries to e.g., prime the conversation state with information about the user's environment. These initial LLM queries may be performed before the user has said anything (before speech-to-text) and may even be discarded if not useful. However, priming inquiries may provide a much broader basis of information and, if performed in advance and cached, will not add to response latency. In other words, pre-emptive query construction may provide a contextually-aware (nearly prescient) user experience.

Furthermore, while the foregoing discussion is described in the context of a specific split of the functional stages of the pipeline across multiple devices, these stages may be aggregated, divided, and/or consolidated in any number of ways. For example, future implementations might consolidate both LLM input specialization and query construction within the smart glasses, etc.

### 3 Token Customization

As previously noted, tokenization breaks input text into tokens. Conventionally, each token is mapped to an embedding vector as a 1:1 relationship in high dimensional space. However, while tokens and embedding vectors are related, they serve fundamentally different purposes. Tokenization allows for text translation to high dimensional space for the LLM, whereas embedding vectors capture meaning and relationships between words in that high dimensional space. In other words, tokens are based on the text similarity between words of a language (e.g., “jumped” and “jumping” both have a common phonetic sound, represented as the text “jump”). In contrast, embedding vectors are based on the similarity in meaning between words of a language (e.g., “jumped” and “jumping” both relate to “jump”).

Conceptually, existing LLMs use tokens because they are designed to take any arbitrary text input and generate output. Tokens efficiently leverage the underlying linguistic patterns of spoken language; its more efficient to tokenize a verb (“jump”, “walk”, “dance”, etc.) and its gerunds separately (“-ing”, “-en”, “-ed”), rather than uniquely tokenize each verb and each gerund form of the verb. Similarly, esoteric words are often more efficiently represented with multiple tokens, rather than dedicating a token to the word (e.g., “Py”+“th”+“ag”+“ore”+“an” versus “Pythagorean”).

A large part of LLM training is focused on identifying the linguistic subdivisions within words for efficiently tokenizing the vocabulary of a language; different languages have different tokenization based on the language's unique linguistic patterns and vocabulary, etc. Furthermore, certain LLMs are focused on specific areas of language; thus, for example, a general-use LLM may have a different training library than a topically-specific LLM. In fact, two LLMs with substantially similar, or even identical, algorithmic implementations may have different tokenization because their training libraries were different. A few LLMs publish their tokenization; for example, https://tiktokenizer.vercel.app/can be used to compare publicly available tokenization output across several popular LLMs.

Embodiments of the present disclosure provide techniques that customize tokens. This has multiple benefits, for example, many LLMs are heavily subsidizing usage costs to increase user adoption, however, the “true” operational cost of LLMs is substantial. Since LLM processing is directly related to the number of tokens being processed, efficiently using tokens could yield significant benefits. In other words, reducing token count will increase processing efficiencies, memory usage, and power consumption, etc. which is distinct from the token limits of the LLM.

As a completely unrelated but important aside, the terms “trap” and “interrupt” are often interchangeably used in the modern computing arts; however, historically, these terms referred to physically distinct computing mechanisms. Both traps and interrupts preempt normal instruction execution; i.e., a trap/interrupts halts the current instruction (and may flush the pipeline), the program counter is then set to the trap/interrupt handler. However, traps were triggered by internal processor logic, whereas interrupts where triggered external to the processor.

Traps were used by embedded software programmers to implement an early form of structured programming. In one specific example, an illegal instruction could be used to trigger a trap, which would cause the trap handler to be run. This was an efficient way to implement a set of commonly run instructions (often at a higher level of privilege). Initially, instruction sets frequently changed as processors evolved, thus there was no guarantee that a future version of the processor would support the same traps. Later, the Motorola 68K family of chips created an instruction set that allowed for reserved space ($A000-$AFFF) that was reserved for custom trap handling; this became more commonly known as “A-traps” or “A-line traps”. A-traps allowed 3rd parties to write software code that could handle very complex instructions within a single line of assembly code. Apple, Inc. popularized the use of custom A-traps in its early MAC ROMs. For example, a custom A-trap might be used to draw a line, rectangle, ellipsis, etc. This also allowed the same binary to be used on later machines since the assembly code could remain the same, and the machine-specific operations were abstracted away from the software.

While custom A-traps are not directly applicable to LLMs, a similar concept may be extended to leverage the functional differences between tokens and embedding vectors. Specifically, embodiments of the present disclosure reserve “custom” token IDs to reference a combination of multiple embedding vectors. In other words, a single token ID can be used to represent multiple embedding vectors.

While the following discussion describes a 1:1 mapping between custom token IDs and custom embedding vectors, any mapping may be substituted with equal success. For example, a custom token ID may reference multiple embedding vectors in their fully elaborated form (a 1:N mapping). In still other embodiments, several custom token IDs may be mapped to one or more embedding vectors (e.g., a M:N mapping of token IDs to embedding vectors).

Typically, a LLM has a vector database that stores mappings of token IDs to embedding vectors. In some embodiments, the LLM may expose an API (application programming interface) or similar communication protocol to support client-defined custom token IDs and their corresponding custom embedding vectors. In one such implementation, the vector database may include a range of custom token IDs that can be configured with a custom embedding vector, based on client input (e.g., a user profile, device configuration, etc.). For example, the custom token IDs may be dynamically configured as part of initializing a session. In other embodiments, the LLM may have a set of defined custom token IDs and their corresponding custom embedding vectors. In one such implementation, the custom token IDs may be provided to the client.

In one implementation, the custom token ID may be assigned to a single custom embedding vector. For example, if a person is a vegetarian, the entire concept of “I am vegetarian” may be embedded as a single custom token and corresponding custom embedding vector. Here, the custom embedding vector is “new” in the sense that it is generated after the LLM training process. However, the custom embedding vector combined or processed from existing vectors; i.e., the concept is not newly trained or learned.

In one implementation, the custom token IDs (and their corresponding custom embedding vectors) may be vendor-specific key phrases/commands that have a specific meaning (embedding vector) that is different than the literal text. This may be particularly useful for tradenames and/or other fanciful phrases that do not have a common usage, have a contrary meaning, and/or would be intentionally excluded from the LLM training for other reasons. Conventionally, such phrases have been handled outside of natural language processing with e.g., dedicated recognition software, etc. In contrast, the embodiments could incorporate them directly within the LLM to enable natural language usage (e.g., in conjunction with slang, idioms, gestures, etc.).

As but one such example, “see-what-I-see” could be used as a vendor-specific key phrase that refers to the act of (or a product that enables) capturing an image for the purpose of an LLM query. Colloquial usage may adapt the key phrase in new and unusual ways that make sense to humans but would be difficult to anticipate/plan for in advance. As but one such example, nominalization (using a verb as a noun) and/or denominalization (using a noun as a verb) often occur as people find new uses for words and phrases. Here, a user might say “could you see-what-I-see it” (verb usage), or “hey, can you grab my see-what-I-see” (noun usage).

In other implementations, the custom token IDs may be dynamically assigned to user-specific key phrases. Anecdotally, many users have habitual mannerisms and/or idioms which are used in conversation; these can be identified during the stitching/dreaming process. More directly, groups of words (phrases) that exceed a threshold frequency of usage may be flagged for customization during stitching/dreaming. The stitcher may create a custom token ID and its corresponding custom embedding vector; the custom token ID and custom embedding vector may be provided to the destination LLM. The user may be alerted when the custom token ID is initially used, to confirm that the inferred meaning is correct. When successfully confirmed, the custom token ID may be incorporated into the user's profile (enabling dissemination of the key phrase to other/future user devices).

In yet another embodiment, custom token IDs may be used for machine-generated prompt augmentations. Consider, for example, previously discussed grocery shopping example. In this case, the pre-prompt, mid-prompt, and post-prompt may use custom token IDs for: “I-am-holding”, “I-already-have”, “but-I-don't-want-to-use”, etc. More directly, some (if not all) of the machine-generated prompt augmentations may use custom token IDs to minimize unnecessary tokens.

In one embodiment, the custom embedding vectors are built from existing embedding vectors. A straightforward implementation might calculate the expected result of the individual tokens/embedding vectors to estimate the custom meaning. For example, the stitcher may calculate (e.g., addition, subtraction, dot product, etc.) the result of “oh, that's a good idea” to generate a custom token ID and corresponding custom embedding vector “oh,-that's-a-good-idea.” This initial estimate may then be verified against actual use. For example, if the user uses this phrase in a sarcastic way, the resulting custom embedding vector may be adjusted emphasize the likely sarcastic meaning. In other words, custom token IDs and/or custom embedding vectors may enable identification of user-specific frequency of use and/or user-specific meaning which are significantly different than usage in the general population.

While the foregoing discussion is presented in the context of user-specific key phrases, artisans of ordinary skill in the related arts will readily appreciate that this technique may be broadly extended to a variety of different applications. As but one such example, people in a certain demographic (ethnicity, gender, age, etc.) may have slang and/or idioms that can be readily accommodated without retraining LLMs. As another such example, certain organizations (e.g., work, communities, etc.) may have specialized terminology, acronyms, and/or other esoteric terms that can be customized for usage with existing LLMs. Furthermore, certain terms have temporal or seasonal use in popular culture. For example, “pumpkin spice latte” is commonly used during certain seasons of the year but may have different meanings and connotations across different segments of society. More generally, customization in this manner may improve familiarity and usage of LLMs among niche language usage and/or enable an LLM to service a broader base of language use than it was trained on.

Importantly, post-training customization re-uses the existing token IDs and embedding vectors to create the custom token and its corresponding custom embedding vector. This is significantly more efficient than re-training the LLM from “scratch” each time (which is both costly and expensive). Additionally, token customization is an incremental adjustment and may be performed only as-needed e.g., limited to the segment of the population and/or the portion of time that it most closely benefits. The custom token IDs also can dynamically adjust over time to match fluidity of use; small groups of people often change language patterns much more frequently than the general population. Furthermore, token customization may be handled at a layer of abstraction above the training process and may be transferred across different LLMs and/or different versions of LLMs.

### 4 Conversation State, Session State, and Multiple Queries

As previously alluded to, embodiments of the present disclosure decouple the user's conversation state from the LLM's session state. This flexibility allows the query constructor to launch multiple queries to multiple destination resources and select one answer from the set of suitable answers. This may enable scenarios where a user has a seamless conversation supported by multiple LLMs, where each LLM only contributes to a portion of the conversation.

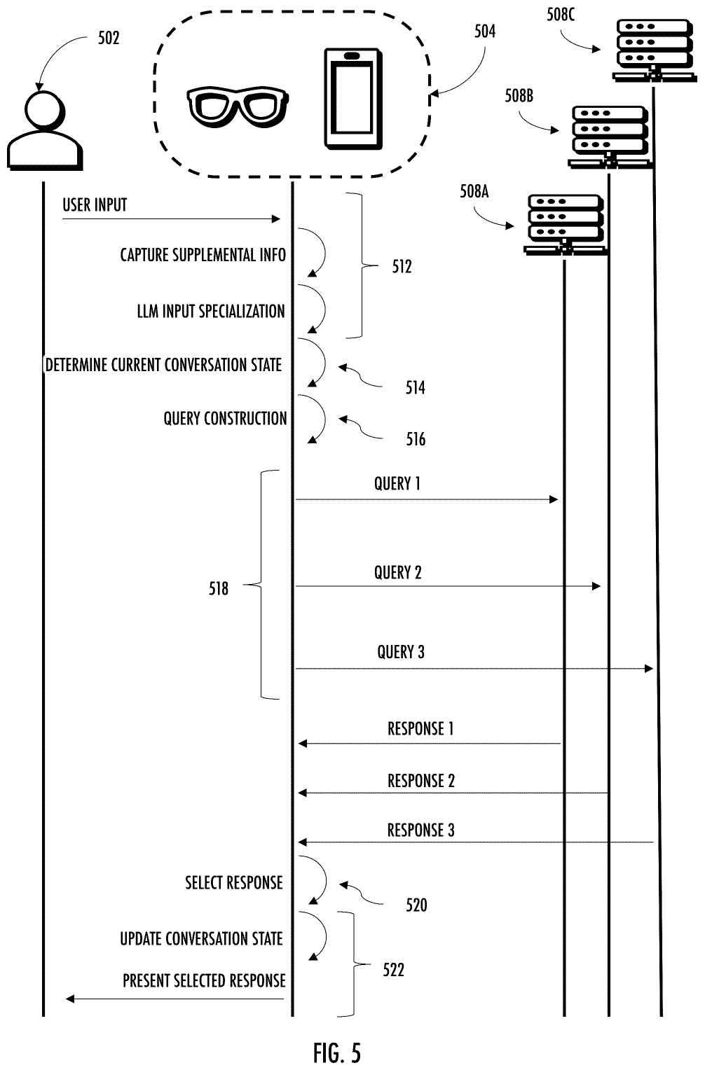

FIG. 5 illustrates a logical ladder diagram of one multi-session conversation, useful to explain various aspects of the present disclosure. As shown, a user 502 has a set of user devices 504 (e.g., smart glasses and/or a smart phone). These components have access to a set of 3^{rd} party large language model (LLM) 508A, 508B, 508C.

At step 512, user input and supplemental information is captured by the set of user devices 504. For example, the user asks a question verbally and the user devices may obtain supplemental information (e.g., gaze point, region-of-interest, image data, location data, IMU data, gestures, etc.). In some cases, the user devices may additionally use LLM input specializers to generate prompt augmentations based on the gathered data, as was discussed above.

At step 514, the user devices determine the current conversation state. In this embodiment, the conversation state is locally stored at the query constructor executing from the smart phone; other embodiments may store the conversation state in the smart glasses or elsewhere (e.g., a cloud service, etc.). Here, the “conversation state” is limited to the context that corresponds to interactions with the user. In other words, the conversation state is limited to the previously selected responses and the queries that were used to generate it. Importantly, the conversation state excludes responses which were previously generated but not selected, and their corresponding queries.

Conceptually, the LLM's session state (context window) defines the text sequence that is used to generate the response. The LLMs own responses form part of the context window; this is needed so that the LLM remains self-consistent. However, in a multi-session conversation, none of the LLMs have a complete version of the conversation. Instead, the query constructor manages the conversation state and disseminates information to the destination LLMs as needed.

Referring back to FIG. 5, the query constructor generates queries for each of the destination LLMs (508A, 508B, 508C) and sends multiple queries simultaneously (steps 516 and 518).

In some embodiments, the queries are constructed (“primed”) so that the LLMs' session state (context window) matches the relevant portion of the conversation state. For example, the relevant portions of the conversation state may be based on recency. In one such implementation, an LLM with a token limit of 4096 might only need the 4096 most recent tokens of the user's conversation state. More complex implementations may consider the user's input and/or surroundings (e.g., relevant subject matter, region-of-interest, gaze point, etc.). For example, the query constructor might filter conversation state based on what the user is talking about and/or looking at. More generally, any information that corresponds to the user's state of mind and/or intent may be used to select the most relevant portions of the conversation state with equal success.

Different LLMs have different token limits, knowledge bases, and/or training and may need different portions of conversation state. For example, a large LLM may receive much more conversational state (e.g., 16K tokens) versus a small LLM (e.g., 4K tokens), etc. Furthermore, different LLMs have different tokenization and/or respond to different types of prompt engineering. In other words, the query constructor may need to separately fashion different queries based on each LLM's capabilities.

While the illustrated example is presented in the context of prompt augmentation, other LLMs may directly expose session state (or context window) information via an API (application programming interface) or similar communication protocol; in such implementations, the query constructor may prime the session state directly via the API.

At step 520, the query constructor selects one response from the received responses. Selection may be based on a variety of criteria e.g., response time, response length, response quality, etc. As but one such example, multiple queries may be launched to models of different complexity; while a simple model can answer more quickly, the complex model may answer more accurately. Here, the first response that sufficiently answers the query is used. As another such example, multiple queries may be launched to LLMs with access to different libraries of information. The most comprehensive response (that is not a hallucination) may be used. In some cases, the query constructor may request additional information to assist in selection (e.g., softmax values, confidence values, etc.).

At step 522, the query constructor updates its conversation state and presents the selected response. As previously noted, the conversation state is updated based on only the selected response and its corresponding query; the unused responses and queries are discarded. In simple embodiments, conversation state may be stored as a text dialogue. In other implementations, the conversation state may be represented as a set of tokens, embedding vectors, and/or any other representation of the conversation state.

Combining the capabilities of multiple LLMs optimizes for the user's experience rather than the LLMs own considerations. In other words, the user experiences fast responses for simple questions, while also benefitting from in-depth answers where necessary. Since conversation state is internally managed by the query constructor, the user does not see the other responses.

As an important aside, single response presentation has particular importance for speech and/or audio presentation. Text responses can be presented, and then updated with new information. Eyes can quickly glance at different portions of text in a non-sequential manner; this allows the user to skip to only the portions that have changed, etc. In contrast, text-to-speech is read start-to-finish; reading a first response, and then correcting the response based on a second better response, is cumbersome/infeasible.

### 4.1 Token Priming and Caching Session State

Certain types of habitual behaviors may repeat a large amount of prompt augmentation. Similarly, certain environments may have very repetitive queries e.g., sports venues, museums, tourist attractions, etc. In some cases, these situations may also have very similar or even identical prompt augmentations, regardless of user. Additionally, LLMs often enforce a session time-out for inactivity (and/or undesirable usage). Session pruning presents an issue for consumer applications that may be intermittently used and/or support a persistent conversational context (e.g., personal assistant type applications, etc.). Ideally, techniques for controlling the session state of the LLM can be used to minimize unnecessary prompt augmentation.

In one embodiment, smart glasses prime an LLM with tokens to force it into a defined conversational state. For example, smart glasses may locally store a persistent conversation state and interface with an LLM via a session state under the LLM's control. The user is unlikely to be in constant conversation with the LLM, thus the LLM may occasionally prune the session state to free up its own resources. The next time a user needs to interact with the LLM, the smart glasses may check to see whether its existing session is still active, or if a new session must be created. If a new session is needed, then the smart glasses start a new session state and prime the session state with tokens to match the relevant portions of its locally stored conversation state.

In the foregoing example, the session state recovery is managed by the smart glasses, using its own conversation state (e.g., the context that corresponds to interactions with the user). However, priming uses tokens which are limited, and causes the LLM to process the tokens/embedding vectors to calculate the key (K) and value (V) vectors, etc.—thus, repeated priming is undesirable. To reduce this cost, embodiments may use session state caching to replicate, suspend, and/or resume session state.

As previously noted, LLMs are based on attention models that assign and manipulate contextual information based on tokens/embedding vectors; most LLMs use 3 vectors: query (Q), key (K), and value (V). Here, “session state caching” refers to caching, archiving, or otherwise storing the current values for key (K) and value (V) for each attention model of the LLM in a session state data structure. In some cases, the session state data structure may also include query (Q) data. More generally, any mechanism for recording the LLM's session state may be substituted with equal success.

Consider the following usage scenario, a user at a restaurant may always want their smart glasses to assist in identifying meals that would fit their dietary considerations. Here, the smart glasses' LLM input specializers and/or persona may repetitively identify the same prompt augmentations e.g., “you are a helpful assistant” and “I am a vegetarian who is also allergic to mushrooms” every time the user visits a location type (restaurant). During the stitching/dreaming process, these prompt augmentations and patterns of use may be used to define a custom LLM session state that can be recalled anytime the user visits a restaurant.

In one specific implementation, the prompt augmentations are input to an LLM and session state caching is used to capture the LLM's current state. The captured state is then associated with a custom LLM session ID that is stored at the LLM. Separately, the smart glasses create a trigger that recalls the custom LLM session ID whenever the user enters a restaurant (based on location data, etc.). Now, anytime the user enters a restaurant, the smart glasses may pre-emptively provide the custom LLM session ID to the LLM; in response, the LLM initializes the key and value data structures based on the custom LLM session state. Unlike token priming, no tokens were transferred or processed (e.g., keys and values are written, not calculated).

As another such example, the LLM and smart glasses may share a custom session identifier that identifies a persistent conversation. The custom session identifier is associated with a session state data structure. During operation, the LLM may write to the session state data structure before pruning; this “suspends” the session state (context window). In some cases, the LLM may locally store the session state data structure. Later, the smart glasses may use the custom session identifier to check whether the LLM has suspended the session or not. If the session is suspended, then the LLM can load the session state data structure in order to “resume” the session state.

Within this context, the term “suspend” and its linguistic derivatives refers to the short-term caching, long-term archival, and/or storing of session state (context windoVw), that enables the session resources to be reclaimed by the system. The term “resume” and its linguistic derivatives refers to the retrieval and/or reconstruction of session state from data.

While the foregoing examples are described in the context of suspend/resume, there may be other data manipulations that may be useful with session state. For example, the session state may be modified, transferred, duplicated, and/or any number of other manipulations. In some embodiments the LLM may expose this data to other entities (e.g., the smart glasses, smart phone, or user's cloud data service) to access and/or store session state data structures.

As previously mentioned, certain trigger events may be associated with session states (e.g., during dreaming/stitching). For example, image captures may be used with image-to-text to identify people, locations, location types, and/or other objects that can be tied to certain types of session states. In one such scenario, image-to-text might identify a restaurant, which causes the smart glasses to load a restaurant session state. In another scenario, image-to-text might identify a person, which causes the smart glasses to load a session state specific to the person. As another example, a geofence or other location data may identify that a person is at a sports arena—the smart glasses may pre-emptively load a session state specific to the current game and the sports arena map (e.g., restrooms, seating, etc.). Various other implementations may be substituted with equal success, given the contents of the present disclosure.

### 5 Pipeline for Foundation Models

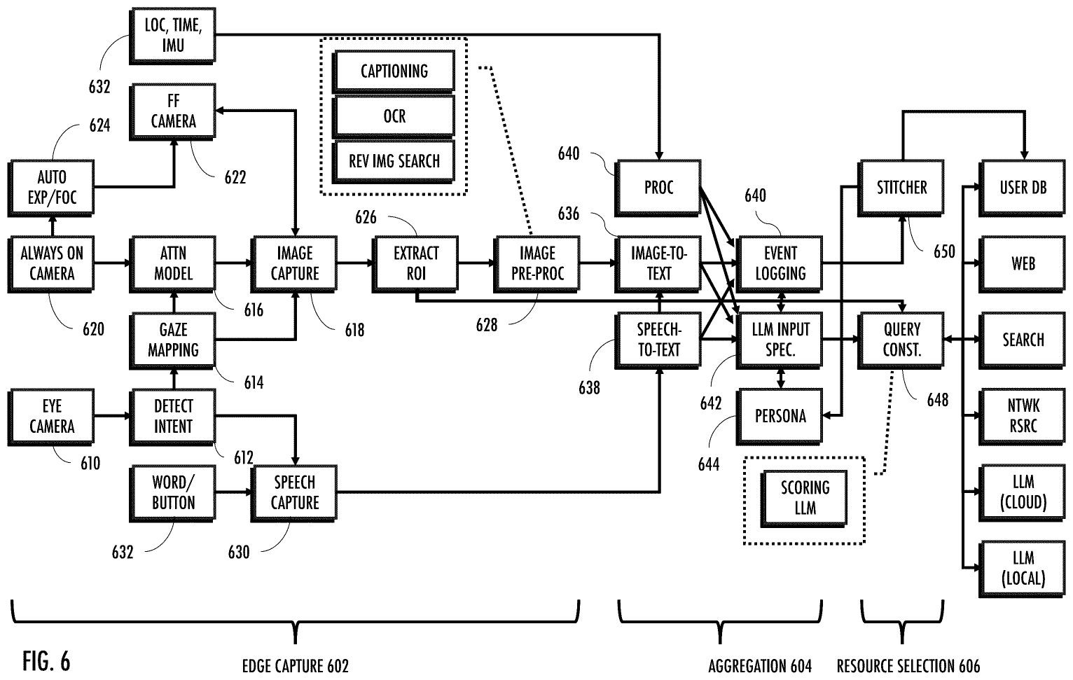

Various aspects of the present disclosure are now discussed with reference to a logical block diagram of one foundation model pipeline for real-time embedded devices depicted within FIG. 6, useful in accordance with various aspects of the present disclosure. The illustrated pipeline is segmented into three (3) functional stages: edge capture stage 602, aggregation stage 604, and resource selection stage 606.

As used herein, the term “pipeline” refers to a set of processing elements that process data in sequence, such that each processing element may also operate in parallel with the other processing elements. For example, a 3-stage pipeline may have first, second, and third processing elements that operate in parallel. During operation, the input of a second processing element includes at least the output of a first processing element, and the output of the second processing element is at least one input to a third processing element.

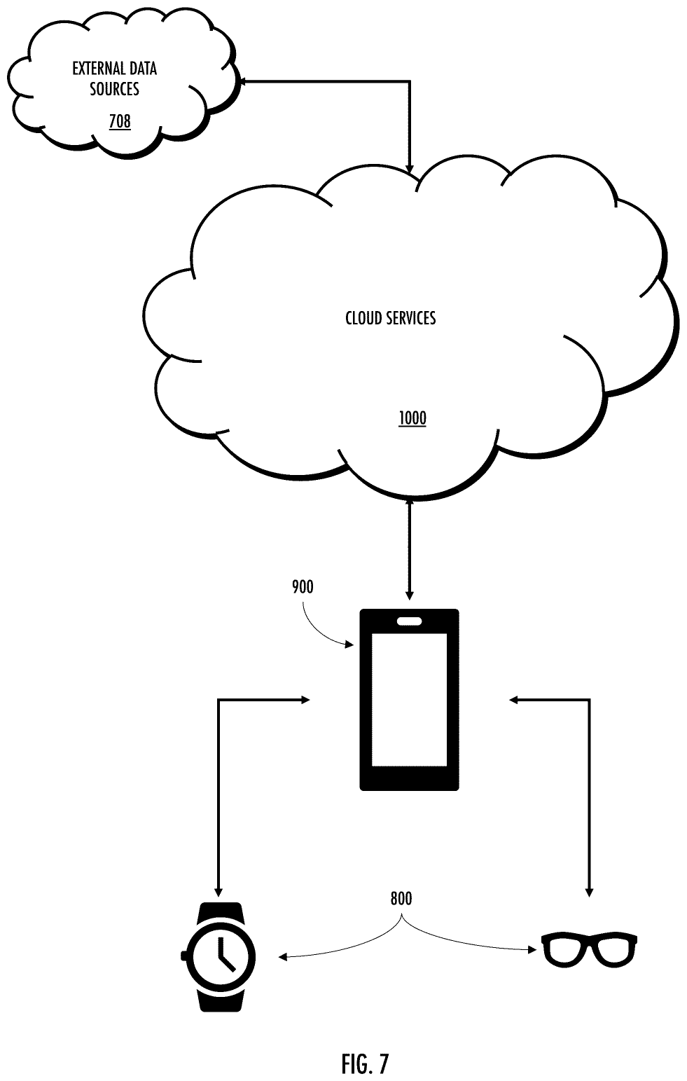

In one implementation, stages of the pipeline are handled within various entities of the mobile ecosystem. FIG. 7 depicts a logical block diagram of one mobile ecosystem that includes: edge device(s) 800, aggregator device(s) 900, intermediary cloud service(s) 1000, and external network resources(s) 708.

The following examples are discussed in the context of edge devices that capture images and/or audio input from the user's environment, an aggregator device that aggregates edge capture data from multiple devices for cloud-based processing, and a cloud-based service that manages resource allocation and/or foundation model processing. More generally, however, artisans of ordinary skill in the related arts will readily appreciate that the functionalities described herein may be combined, divided, hybridized, and/or augmented within different entities. For example, a smart phone may have both edge functionality (e.g., capturing location information via GPS, etc.) as well as aggregator functionality (e.g., combining data streams from a connected smart glasses and smart watch). In another such example, a sufficiently capable smart phone may implement foundation model processing locally (rather than at a cloud service). Here, the smart phone may caption the instantaneous user context (or perform other forms of pre-processing) and/or aggregate the instantaneous user context for use with a local small LLM. The small LLM may then process the text data to identify what the user's attention is focused on. As yet another example, multiple distinct edge devices (e.g., smart glasses, smart phone, etc.) may communicate directly with a cloud service, which performs both aggregation as well as resource allocation, etc.

While the following discussion is presented in the context of a smart phone aggregator device that maintains a Bluetooth personal area network (PAN) with edge devices (smart glasses and smart watch), other types of devices and/or networks may be substituted with equal success. For example, a laptop, smart glasses, a smart watch, or smart car may provide network connectivity via hotspot, etc. Similarly, while present discussion is described in the context of Bluetooth, other networking technologies may be substituted with equal success. For instance, a smart phone may use Bluetooth/Wi-Fi ad hoc networking to connect to multiple devices of the user's mobile area network (e.g., smart glasses, smart watch, smart car, etc.).

### 5.1 Edge Capture

Edge devices refer to devices that are at the “edge” of the system-functionally, edge devices are used to capture the user's interactions and data about the environment and/or other instantaneous user context.

As a practical matter, edge devices may have a broad range of capability. For example, simple devices may capture data with sensors and pass the raw data to more sophisticated devices in the ecosystem. More sophisticated implementations may pre-process the instantaneous user context to detect user interest. Complex implementations may also aggregate data from other devices, implement localized processing, and/or even perform foundation model-type processing (e.g., large language models, large multimodal models, etc.). More broadly, any device that collects instantaneous user context may provide “edge device” functionality. For example, a smart phone may passively collect location information as part of its background tasks. Similarly, heart rate data may be collected from a smart watch, etc.

Edge devices may enforce localized control over data capture. For example, a user may enable or disable the cameras, microphones, and/or other sensors of their smart glasses for certain times of the day, certain activities, and/or certain locations. In some variants, the user may have the ability to provide default access settings and/or manually override default access settings.

While the following discussions are primarily discussed in the context of user-triggered data captures (which the user is aware of), edge devices may also receive and/or service capture requests from other entities (which the user may not be aware of). For example, an aggregator device may request a data capture either for its own operations, or on behalf of another entity (e.g., an LLM may need additional information about the user's context in order to provide a response). In some cases, the user may request/require notification for such accesses; other forms of access control may also be used (e.g., rule-based, etc.).

### 5.1.1 Implementation and Design Considerations

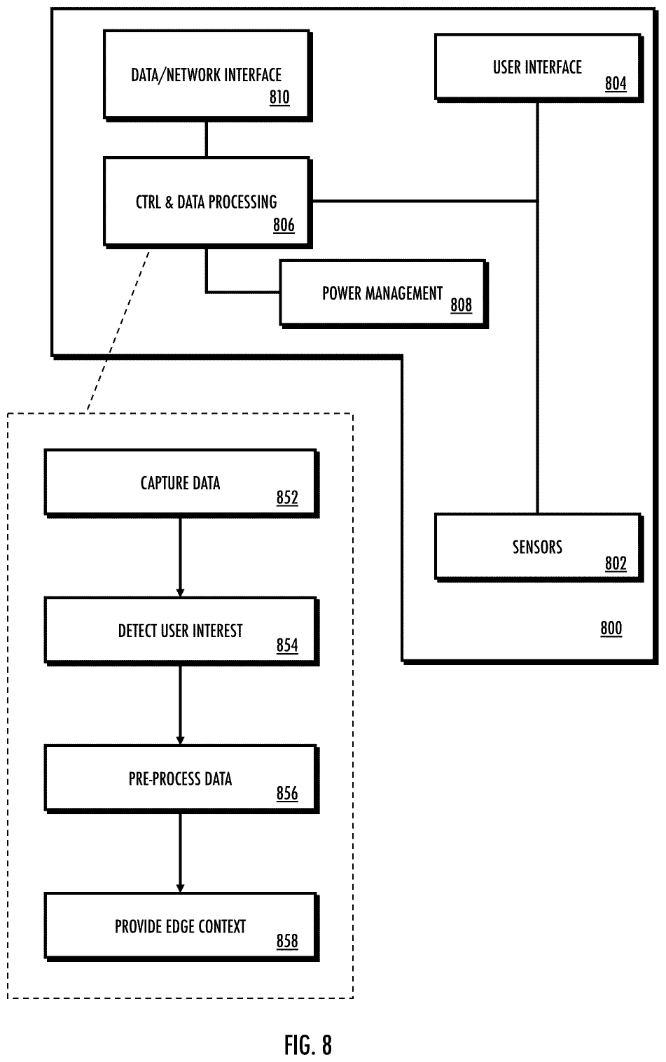

FIG. 8 is a logical block diagram of edge device 800. The edge device 800 includes: a sensor subsystem 802, a user interface subsystem 804, control and data processing logic 806, a power management subsystem 808, and a data/network interface 810.

The sensor subsystem 802 captures data from the environment. The user interface subsystem 804 monitors the user for user interactions and renders data for user consumption. The control and data processing logic 806 obtains data generated by the user, other devices, and/or captured from the environment, to perform calculations and/or data manipulations. The resulting data may be stored, rendered to the user, transmitted to another party, or otherwise used by the edge device to carry out its tasks. The power management subsystem 808 supplies and controls power for the edge device components. The data/network interface 810 converts data for transmission to another device via removeable storage media or some other transmission medium. In some cases, the edge device may additionally include a physical frame that attaches the edge device to the user, freeing either one or both hands (hands-free operation).

The various logical subsystems described herein may be combined, divided, hybridized, and/or augmented within various physical components of a device. As but one such example, an inward-facing camera and outward-facing camera may be implemented as separate, or combined, physical assemblies. As another example, power management may be centralized within a single component or distributed among many different components; similarly, data processing logic may occur in multiple components of the edge device. More generally, the logical block diagram illustrates the various functional components of the edge device, which may be physically implemented in a variety of different manners.

Referring first to the sensor subsystem, a “sensor” refers to any electrical and/or mechanical structure that measures, and records, parameters of the physical environment as analog or digital data. Most consumer electronics devices incorporate multiple different modalities of sensor data; for example, visual data may be captured as images and/or video, audible data may be captured as audio waveforms (or their frequency representations), inertial measurements may be captured as quaternions, Euler angles, or other coordinate-based representations.

While the present disclosure is described in the context of audio data, visual data, and/or IMU data, artisans of ordinary skill in the related arts will readily appreciate that the raw data, metadata, and/or any derived data may be substituted with equal success. For example, an image may be provided along with metadata about the image (e.g., facial coordinates, object coordinates, depth maps, etc.). Post-processing may also yield derived data from raw image data; for example, a neural network may process an image and derive one or more activations.

In one embodiment, the sensor subsystem may include: one or more camera module(s), an audio module, an accelerometer/gyroscope/magnetometer (also referred to as an inertial measurement unit (IMU)), a display module (not shown), and/or Global Positioning System (GPS) system (not shown). The following sections provide detailed descriptions of the individual components of the sensor subsystem.

A camera lens bends (distorts) light to focus on the camera sensor. The camera lens may focus, refract, and/or magnify light. It is made of transparent material such as glass or plastic and has at least one curved surface. When light passes through a camera lens, it is bent or refracted in a specific way, which can alter the direction, size, and/or clarity of the image that is formed.

A camera sensor senses light (luminance) via photoelectric sensors (e.g., photosites). A color filter array (CFA) filters light of a particular color; the CFA provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image. Notably, most imaging formats are defined for the human visual spectrum; however, machine vision may use other variants of light. For example, a computer vision camera might operate on direct raw data from the image sensor with a RCCC (Red Clear Clear Clear) color filter array that provides a higher light intensity than the RGB color filter array used in media application cameras.

A camera sensor may be read using the readout logic. Conventional readout logic uses row enables and column reads to provide readouts in a sequential row-by-row manner. Historically, display devices were unaware of image capture but could optimize for their own raster-graphics scan line style of operation. Conventional data formats assign one dimension to be “rows” and another dimension to be “columns”; the row and column nomenclature is used by other components and/or devices to access data. Most (if not all) devices assume that scan lines are rows that run horizontally (left to right), and columns that run vertically (top to bottom), consistent with conventional raster-scan style operation.

A “digital image” is a two-dimensional array of pixels (or binned pixels). Virtually all imaging technologies are descended from (and inherit the assumptions of) raster-graphics displays which displayed images line-by-line. The aspect ratio of a digital image may be any number of pixels wide and high. However, images are generally assumed to be longer than they are tall (the rows are larger than columns).

During operation, the edge device may make use of multiple camera systems to assess user interactions and the physical environment. For example, smart glasses may have one or more outward-facing cameras to capture the user's environment. Multiple outward-facing cameras can be used to capture different fields-of-view and/or ranges. Cameras with a non-fixed/“zoom” lens may also change its focal length to capture multiple fields of view. For example, a medium range camera might have a horizontal field-of-view (FOV) of 70°-120° whereas long range cameras may use a FOV of 35°, or less, and have multiple aperture settings. In some cases, a “wide” FOV camera (so-called fisheye lenses provide between 120° and) 195° may be used to capture periphery information along two transverse axes. In some implementations, one or more anamorphic cameras may be used to capture a wide FOV in a first axis (major axis) and a medium range FOV in a second axis (minor axis). In addition, the smart glasses may have one or more inward-facing cameras to capture the user's interactions. Multiple cameras can be used to capture different views of the eyes for eye-tracking. In some implementations, one or more anamorphic cameras may be used to track eye movement. Other implementations may use normal FOV cameras that are stitched together or otherwise processed jointly.

More generally, however, any camera lens or set of camera lenses may be substituted with equal success for any of the foregoing tasks; including e.g., narrow field-of-view (10° to 90°) and/or stitched variants (e.g., 360° panoramas). While the foregoing techniques are described in the context of perceptible light, the techniques may be applied to other electromagnetic (EM) radiation capture and focus apparatus including without limitation: infrared, ultraviolet, and/or X-ray, etc.

The camera module(s) may include on-board image signal processing and/or neural network processing. On-board processing may be implemented within the same silicon or on a stacked silicon die (within the same package/module). Silicon and stacked variants reduce power consumption relative to discrete component alternatives that must be connected via external wiring, etc. Processing functionality is discussed further below.

The camera module(s) incorporates on-board logic to generate image analysis statistics and/or perform limited image analysis. As but one such example, the camera sensor may generate integral image data structures at varying scales. In some cases, the integral images may have reduced precision (e.g., only 8-bits, 12-bits, 16-bits, of precision). Notably, even at reduced precision, integral images may be used to calculate the sum of values in a patch of an image. This may enable lightweight computer vision algorithms that perform detection and/or recognition of objects, faces, text, etc.

More generally, a variety of applications may leverage preliminary image analysis statistics. For example, computer-assisted searches and/or other recognition algorithms, etc. are discussed in greater detail within U.S. patent application Ser. No. 18/185,362 filed Mar. 16, 2023, and entitled “APPARATUS AND METHODS FOR AUGMENTING VISION WITH REGION-OF-INTEREST BASED PROCESSING”, U.S. patent application Ser. No. 18/185,364 filed Mar. 16, 2023, and entitled “APPARATUS AND METHODS FOR AUGMENTING VISION WITH REGION-OF-INTEREST BASED PROCESSING”, and U.S. patent application Ser. No. 18/185,366 filed Mar. 16, 2023, and entitled “APPARATUS AND METHODS FOR AUGMENTING VISION WITH REGION-OF-INTEREST BASED PROCESSING”, previously incorporated by reference above.

Various embodiments of the present disclosure may additionally leverage improvements to scalable camera sensors and/or asymmetric camera lenses, discussed in greater detail within U.S. patent application Ser. No. 18/316,181 filed May 11, 2023, and entitled “METHODS AND APPARATUS FOR SCALABLE PROCESSING”, U.S. patent application Ser. No. 18/316,214 filed May 11, 2023, and entitled “METHODS AND APPARATUS FOR SCALABLE PROCESSING”, U.S. patent application Ser. No. 18/316,206 filed May 11, 2023, and entitled “METHODS AND APPARATUS FOR SCALABLE PROCESSING”, U.S. patent application Ser. No. 18/316,203 filed May 11, 2023, and entitled “APPLICATIONS FOR ANAMORPHIC LENSES”, U.S. patent application Ser. No. 18/316,218 filed May 11, 2023, and entitled “APPLICATIONS FOR ANAMORPHIC LENSES”, U.S. patent application Ser. No. 18/316,221 filed May 11, 2023, and entitled “APPLICATIONS FOR ANAMORPHIC LENSES”, U.S. patent application Ser. No. 18/316,225 filed May 11, 2023, and entitled “APPLICATIONS FOR ANAMORPHIC LENSES”, previously incorporated by reference above.

An audio module typically incorporates a microphone, speaker, and an audio codec. The microphone senses acoustic vibrations and converts the vibrations to an electrical signal (via a transducer, condenser, etc.). The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats. To generate audible sound, the audio codec obtains audio data and decodes the data into an electrical signal. The electrical signal can be amplified and used to drive the speaker to generate acoustic waves.

Commodity audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.).

An audio module may have any number of microphones and/or speakers. For example, multiple speakers may be used to generate stereo sound and multiple microphones may be used to capture stereo sound. More broadly, any number of individual microphones and/or speakers can be used to constructively and/or destructively combine acoustic waves (also referred to as beamforming). The audio module may include on-board audio processing and/or neural network processing to assist with voice analysis and synthesis.

The inertial measurement unit (IMU) may include one or more accelerometers, gyroscopes, and/or magnetometers. Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both head direction and speed).

More generally, however, any scheme for detecting user velocity (direction and speed) may be substituted with equal success for any of the foregoing tasks. Other useful information may include pedometer and/or compass measurements. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

Global Positioning System (GPS) is a satellite-based radio navigation system that allows a user device to triangulate its location anywhere in the world. Each GPS satellite carries very stable atomic clocks that are synchronized with one another and with ground clocks. Any drift from time maintained on the ground is corrected daily. In the same manner, the satellite locations are known with great precision. The satellites continuously broadcast their current position. During operation, GPS receivers attempt to demodulate GPS satellite broadcasts. Since the speed of radio waves is constant and independent of the satellite speed, the time delay between when the satellite transmits a signal and the receiver receives it is proportional to the distance from the satellite to the receiver. Once received, a GPS receiver can triangulate its own four-dimensional position in spacetime based on data received from multiple GPS satellites. At a minimum, four satellites must be in view of the receiver for it to compute four unknown quantities (three position coordinates and the deviation of its own clock from satellite time). In so-called “assisted GPS” implementations, ephemeris data may be downloaded from cellular networks to reduce processing complexity (e.g., the receiver can reduce its search window). The IMU may include on-board telemetry processing and/or neural network processing to assist with telemetry analysis and synthesis.

Referring now to the user interface subsystem, the “user interface” refers to the physical and logical components of the edge device that interact with the human user. A “physical” user interface refers to electrical and/or mechanical devices that the user physically interacts with. An “augmented reality” user interface refers to a user interface that incorporates an artificial environment that has been overlaid on the user's physical environment. A “virtual reality” user interface refers to a user interface that is entirely constrained within a “virtualized” artificial environment. An “extended reality” user interface refers to any user interface that lies in the spectrum from physical user interfaces to virtual user interfaces.

The user interface subsystem may encompass the visual, audio, and tactile elements of the device that enable a user to interact with it. In addition to physical user interface devices that use physical buttons, switches, and/or sliders to register explicit user input, the user interface subsystem may also incorporate various components of the sensor subsystem to sense user interactions. For example, the user interface may include: a display module to present information, eye-tracking camera sensor(s) to monitor gaze fixation, hand-tracking camera sensor(s) to monitor for hand gestures, a speaker to provide audible information, and a microphone to capture voice commands, etc.

The display module is an output device for presentation of information in a visual form. Different display configurations may internalize or externalize the display components within the lens. For example, some implementations embed optics or waveguides within the lens and externalize the display as a nearby projector or micro-LEDs. As another such example, some implementations project images into the eyes.

The display module may be incorporated within the device as a display that is overlaps the user's visual field. Examples of such implementations may include so-called “heads up displays” (HUDs) that are integrated within the lenses, or projection/reflection type displays that use the lens components as a display area. Existing integrated display sizes are typically limited to the lens form factor, and thus resolutions may be smaller than handheld devices e.g., 640×320, 1280×640, 1980×1280, etc. For comparison, handheld device resolutions that exceed 2560×1280 are not unusual for smart phones, and tablets can often provide 4K UHD (3840×2160) or better. In some embodiments, the display module may be external to the glasses and remotely managed by the device (e.g., screen casting). For example, smart glasses can encode a video stream that is sent to a user's smart phone or tablet for display.

The display module may be used where smart glasses present and provide interaction with text, pictures, and/or AR/XR objects. For example, the AR/XR object may be a virtual keyboard and a virtual mouse. During such operation, the user may invoke a command (e.g., a hand gesture) that causes the smart glasses to present the virtual keyboard for typing by the user. The virtual keyboard is provided by presenting images on the smart glasses such that the user may type without contact to a physical object. One of ordinary skill in the art will appreciate that the virtual keyboard (and/or mouse) may be displayed as an overlay on a physical object, such as a desk, such that the user is technically touching a real-world object. However, input is measured by tracking user movements relative to the overlay, previous gesture position(s), etc. rather than receiving a signal from the touched object (e.g., as a conventional keyboard would).

The user interface subsystem may incorporate an “eye-tracking” camera to monitor for gaze fixation (a user interaction event) by tracking saccadic or microsaccadic eye movements. Eye-tracking embodiments may greatly simplify camera operation since the eye-tracking data is primarily captured for standby operation (discussed below). In addition, the smart glasses may incorporate “hand-tracking” or gesture-based inputs. Gesture-based inputs and user interactions are more broadly described within e.g., U.S. patent application Ser. No. 18/061,203 filed Dec. 2, 2022, and entitled “SYSTEMS, APPARATUS, AND METHODS FOR GESTURE-BASED AUGMENTED REALITY, EXTENDED REALITY”, U.S. patent application Ser. No. 18/061,226 filed Dec. 2, 2022, and entitled “SYSTEMS, APPARATUS, AND METHODS FOR GESTURE-BASED AUGMENTED REALITY, EXTENDED REALITY”, and U.S. patent application Ser. No. 18/061,257 filed Dec. 2, 2022, and entitled “SYSTEMS, APPARATUS, AND METHODS FOR GESTURE-BASED AUGMENTED REALITY, EXTENDED REALITY”, previously incorporated by reference in their entireties.

While the present discussion describes inward-facing and hand-tracking cameras, the techniques are broadly applicable to any outward-facing and inward-facing cameras. As used herein, the term “outward-facing” refers to cameras that capture the surroundings of a user and/or the user's relation relative to the surroundings. For example, a rear outward-facing camera could be used to capture the surroundings behind the user. Such configurations may be useful for gaming applications and/or simultaneous localization and mapping (SLAM-based) applications. As used herein, the term “inward-facing” refers to cameras that capture the user e.g., to infer user interactions, etc.

The user interface subsystem may incorporate microphones to collect the user's vocal instructions as well as the environmental sounds. As previously noted above, the audio module may include on-board audio processing and/or neural network processing to assist with voice analysis and synthesis.

The user interface subsystem may also incorporate speakers to reproduce audio waveforms. In some cases, the speakers may incorporate noise reduction technologies and/or active noise cancelling to cancel out external sounds, creating a quieter listening environment for the user. This may be particularly useful for sensory augmentation in noisy environments, etc.

Functionally, the data/network interface subsystem enables communication between devices. For example, the edge device may communicate with an aggregator device. In some cases, the edge device may also need to access remote data (accessed via an intermediary network). For example, a user may want to look up a menu from a QR code (which visually embeds a network URL) or store a captured picture to their social network, social network profile, etc. In some cases, the user may want to store data to removable media. These transactions may be handled by a data interface and/or a network interface.

The network interface may include both wired interfaces (e.g., Ethernet and USB) and/or wireless interfaces (e.g., cellular, local area network (LAN), personal area network (PAN)) to a communication network. As used herein, a “communication network” refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). For example, smart glasses may directly connect, or indirectly tether to another device with access to, the Internet. “Tethering” also known as a “mobile hotspot” allows devices to share an internet connection with other devices. For example, a smart phone may use a second network interface to connect to the broader Internet (e.g., 5G/6G cellular); the smart phone may provide a mobile hotspot for a smart glasses device over a personal area network (PAN) interface (e.g., Bluetooth/Wi-Fi), etc.

The data interface may include one or more removeable media. Removeable media refers to a memory that may be attached/removed from the edge device. In some cases, the data interface may map (“mount”) the removable media to the edge device's internal memory resources to expand its operational memory.

The control and data subsystem controls the operation of a device and stores and processes data. Logically, the control and data subsystem may be subdivided into a “control path” and a “data path.” The data path is responsible for performing arithmetic and logic operations on data. The data path generally includes registers, arithmetic and logic unit (ALU), and other components that are needed to manipulate data. The data path also includes the memory and input/output (I/O) devices that are used to store and retrieve data. In contrast, the control path controls the flow of instructions and data through the subsystem. The control path usually includes a control unit, that manages a processing state machine (e.g., a program counter which keeps track of the current instruction being executed, instruction register which holds the current instruction being executed, etc.). During operation, the control path generates the signals that manipulate data path operation. The data path performs the necessary operations on the data, and the control path moves on to the next instruction, etc.

The control and data processing logic may include one or more of: a central processing unit (CPU), an image signal processor (ISP), one or more neural network processors (NPUs), and their corresponding non-transitory computer-readable media that store program instructions and/or data. In one exemplary embodiment, the control and data subsystem includes processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

Different processor architectures attempt to optimize their designs for their most likely usages. More specialized logic can often result in much higher performance (e.g., by avoiding unnecessary operations, memory accesses, and/or conditional branching). For example, a general-purpose CPU may be primarily used to control device operation and/or perform tasks of arbitrary complexity/best-effort. CPU operations may include, without limitation: operating system (OS) functionality (power management, UX), memory management, gesture-specific tasks, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or autoexposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization.

In some cases, the device may include one or more neural network processors (NPUs). Unlike the Turing-based processor architectures, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Conceptually, neural network processing uses a collection of small nodes to loosely model the biological behavior of neurons. Each node receives inputs, and generates output, based on a neuron model (usually a rectified linear unit (ReLU), or similar). The nodes are connected to one another at “edges”. Each node and edge are assigned a weight. Each processor node of a neural network combines its inputs according to a transfer function to generate the outputs. The set of weights can be configured to amplify or dampen the constituent components of its input data. The input-weight products are summed and then the sum is passed through a node's activation function, to determine the size and magnitude of the output data. “Activated” neurons (processor nodes) generate output “activations”. The activation may be fed to another node or result in an action on the environment. Coefficients may be iteratively updated with feedback to amplify inputs that are beneficial or dampen inputs that are not.

The behavior of the neural network may be modified during an iterative training process by adjusting the node/edge weights to reduce an error gradient. The computational complexity of neural network processing is a function of the number of nodes in the network. Neural networks may be sized (and/or trained) for a variety of different considerations. For example, increasing the number of nodes may improve performance and/or robustness noise rejection whereas reducing the number of nodes may reduce power consumption and/or improve latency.

Typically, machine learning algorithms are “trained” until their predicted outputs match the desired output (to within a threshold similarity). Training is broadly categorized into “offline” training and “online” training. Offline training models are trained once using a static library, whereas online training models are continuously trained on “live” data. Offline training allows for reliable training according to known data and is suitable for well-characterized behaviors. Furthermore, offline training on a single data set can be performed much faster and at a fixed power budget/training time, compared to online training via live data. However, online training may be necessary for applications that must change based on live data and/or where the training data is only partially-characterized/uncharacterized. Many implementations combine offline and online training to e.g., provide accurate initial performance that adjusts to system-specific considerations over time.

In some implementations, the NPU may be incorporated within a sensor (e.g., a camera sensor) to process data captured by the sensor. By coupling an NPU closely (on-die) with the sensor, the processing may be performed with lower power demand. In one aspect, the sensor processor may be designed as customized hardware that is dedicated to processing the data necessary to enable interpretation of relatively simple user interaction(s) to enable more elaborate gestures. In some cases, the sensor processor may be coupled to a memory that is configured to provide storage for the data captured and processed by the sensor. The sensor processing memory may be implemented as SRAM, MRAM, registers, or a combination thereof.

Other processor subsystem implementations may multiply, combine, further subdivide, augment, and/or subsume the foregoing functionalities within these or other processing elements. For example, multiple ISPs may be used to service multiple camera sensors. Similarly, neural network functionality may be subsumed with either CPU or ISP operation via software emulation.

In one embodiment, the control and data processing subsystem may be used to store data locally at the device. In one exemplary embodiment, data may be stored as non-transitory symbols (e.g., bits read from non-transitory computer-readable mediums). In one specific implementation, a memory subsystem including non-transitory computer-readable medium is physically realized as one or more physical memory chips (e.g., NAND/NOR flash) that are logically separated into memory data structures. The memory subsystem may be bifurcated into program code and/or program data. In some variants, program code and/or program data may be further organized for dedicated and/or collaborative use.

In some embodiments, the program code may be statically stored within the device as firmware. In other embodiments, the program code may be dynamically stored (and changeable) via software updates. In some such variants, software may be subsequently updated by external parties and/or the user, based on various access permissions and procedures.

### 5.1.2 User Context Capture and Interest Detection

As previously alluded to, the edge device 800 may provide edge capture functionality (edge capture stage 602 depicted within FIG. 6). Here, the edge device may have multiple different modalities of capture to obtain instantaneous user context. The following discussions present a few illustrative capture scenarios.

As shown in FIG. 6, a first capture modality may be based on visual information such as images and/or video. In one specific implementation, visual captures may be triggered by “user intent”. Specifically, an inward-facing camera 610 detects intent 612 and performs gaze mapping 614. The resulting user intent and gaze (e.g., vector, gaze point, etc.) may be used by an attention model 616 to trigger image capture logic 618. Another visual capture mechanism may be based on computer vision recognition; here, the always-on camera 620 directly feeds the attention model 616; when the attention model 616 identifies a trigger condition (e.g., pre-defined or learned trigger conditions) the attention model 616 triggers image capture logic 618.

Under either scenario, image capture logic 618 causes the outward-facing camera 622 to capture an image. The outward-facing camera 622 may have long wake times (e.g., 1 second or more); keeping the outward-facing camera 622 powered-on to avoid wake-up may consume significant amounts of power. Thus, optimized variants may prime the outward-facing camera 622 with autoexposure/autofocus information 624 from the always-on camera 620. In other words, the outward-facing camera 622 may be configured for a likely capture while other operations (e.g., intent detection, gaze mapping, attention model, etc.) are being performed. This can greatly reduce (or completely mask) the user's perception of capture delay. The trade-off between “false alarms” (primed but no resulting capture) and “missed opportunities” (capture triggered while without priming) may be adjusted according to user preference, design constraints, etc.

Captured images may be reduced in size, resolution, etc. to a region-of-interest (extract ROI 626) and/or pre-processed (image pre-processing 628). Reducing data sizes for transfer and/or downstream processing can improve processing efficiency, reduce power consumption, and/or improve latency, etc. Pre-processing may also be used to compress, encode, annotate, filter, and/or otherwise prepare the images for transfer to, and/or processing by, the aggregation stage 604 (discussed elsewhere).

A second capture modality may be based on audio information such as voice and/or environmental audio. Much like visual captures, audio captures may be triggered by “user intent”. For example, the inward-facing camera 610 may detect intent 612 and infer that the user is issuing a voice instruction. In this case, the user's speech is captured (speech capture logic 630) and provided to the aggregation stage 604 (discussed elsewhere). Some embodiments may also use keyword triggers and/or button triggered voice commands 632.

Other capture modalities may include e.g., location data, motion data (e.g., inertial motion, velocity, etc.), time, etc. Some implementations may monitor the user's physiology with biometric sensors (heart rate, oxygen, blood pressure, etc.). More generally, a variety of edge capture applications may be substituted with equal success.

Referring now back to FIG. 8, one specific implementation of the edge device 800 may include a non-transitory computer-readable medium that includes a routine that captures instantaneous user context and/or pre-processes the instantaneous user context to detect user interest. When executed by the control and data subsystem, the first routine causes the edge device to: capture data from the sensor subsystem, pre-process the captured data to generate instantaneous user context, and provide the stream of instantaneous user context to another device (e.g., an aggregator device, a cloud service, etc.). In some variants, the pre-processing may additionally include detecting user interest. The following discussion explores these steps in more detail.

At step 852, the edge device captures data via the sensor subsystem. While the following discussion is discussed in the context of one edge device, most usage scenarios may have multiple edge devices. For example, a mobile ecosystem might include smart glasses, a smart phone, and a smart watch, all of which are actively capturing information about a user and their environment. While the present disclosure is primarily discussed in the context of audio/visual data, location, and motion data, virtually any sensed data may be substituted with equal success. Data captured by the sensor subsystem may represent specific physical properties and changes in the user and/or environment.

A capture refers to the process of collecting data or information at a specific point in time using a designated device or system. Captures can be initiated in various ways depending on the requirements of the task or system. They can be triggered automatically by specific events or conditions, such as a motion sensor activating when movement is detected or a camera capturing an image when a button is pressed, gesture detected, voice command, etc. Captures can also be scheduled to occur at regular intervals (e.g., throughout a user's daily routine). Additionally, captures can be externally triggered by another entity (e.g., an aggregator device, cloud service, etc.). For example, an aggregator may need additional edge context to supplement its existing data, similarly a cloud service may request edge context to understand a user's intention.

In some cases, captures may incorporate metadata to provide information about the captured data. For example, metadata may include type, format, mode of capture, time of capture, etc. Metadata may be particularly important for e.g., aligning, comparing, and/or processing different types of data. For example, sample rates and/or timestamps may be useful to align data captured on different time scales; resolution, image size, etc. may be useful to scale images captured on different sensors, etc.

In one embodiment, captures may be restricted based on access control restrictions. Within the context of an edge device, access control refers to the mechanisms and policies that regulate when, where, who and/or what can interact with the sensor, including triggering capture, reading data, configuring its settings, and/or any other sensor-based functionality. For example, access control may be based on permissions and authentication protocols to ensure that only authorized individuals, devices, or systems can access the sensor's functions and data.

In some variants, access control may be based on a defined set of rules and/or conditions. For example, the user may identify times, locations, and/or applications that may trigger data capture. In some examples, the user may additionally identify default rules to grant/deny, as well as the ability to manually override the default rules based on application-specific considerations. In some cases, manual override may require e.g., biometric safeguards, password protection, two-factor authentication, etc.

At step 854, the edge device may additionally detect user interest. In some embodiments, the user interest may be based on a gaze point, verbal instruction, or other user interaction. More broadly, captured data may be substantial, yet not all of it may be of interest. Focusing and/or filtering captured data may be useful to reduce processing burden, memory footprint, power consumption, etc. For example, a user may only be focused on a region-of-interest (within a larger image capture), providing the entire captured image may be unnecessary and/or inefficient. Similarly, a user may only be focused on data captured at a specific moment (or temporal range), data outside of the selected window may be unrelated and/or add noise.

In some embodiments, the user interest may be explicitly signaled by the user. For example, the user may provide visual, audible, and/or gestural cues that can be used to interpret their interest. In other embodiments, user interest may be inferred from the captured data based on e.g., generalized rules, training, and/or previous usage. In still other embodiments, user interest may be received via an out-of-band mechanism. For example, an edge device may be notified of user interest from an aggregator device and/or intermediary device.

At step 856, the edge device pre-processes the captured data to generate instantaneous user context. Pre-processing may prepare captured data for downstream analysis by cleaning and conversion to a suitable format. Cleaning generally includes tasks such as removing noise and outliers, handling missing values, normalizing or scaling data. For example, in image processing, pre-processing might involve resizing images, adjusting brightness, and filtering out noise to enhance quality. Conversion refers to any translation of data from e.g., one domain to another domain. For example, time-domain inputs may be converted to frequency-domain spectral coefficients via FFT, DCT, etc. Other examples of conversions may translate between modalities, e.g., image-to-text, speech-to-text, etc.

As previously noted, “instantaneous user context” refers to user context that is specific to a specific instant of time. Here, the edge device captures data that represents the user and their environment at the moment of capture. Instantaneous user context may be (and usually is) different than other aspects of user context which may be accumulated and/or persist over spatial and/or temporal usage.

As previously alluded to, the user context may include user generated prompts (e.g., verbal commands, gaze point, gestures, and/or other forms of user interactions). In such variants, the user context may be pre-processed with an input specializer to provide more context for downstream processing. For example, an LLM input specializer may be used to augment user context with additional input for an LLM. Functionally, an LLM input specializer augments the user's prompt in view of captured data and/or personalization data (“persona”). In one specific implementation, the LLM input specializer maintains a map of different prompt augmentations (pre-prompts, mid-prompts, post-prompts) for different types of questions.

In one specific implementation, image-to-text and/or speech-to-text processes the input data to generate labels. Mapping logic maps the labels various classification areas. For example, a person looking at a menu (and/or asking about a menu item) would be mapped to the general category of food, etc. Here, the LLM input specializer may provide prompt augmentation based on a set of previously stored food-related prompt augmentations.

While the foregoing example uses machine generated labels for prompt augmentation, other types of augmentation may be based on key words or key phrases. For example, the LLM input specializer may have a list of specific words or phrases that are commonly used (generic or user-specific) together with a variety of different locations, activities, etc. Such keywords may include e.g.: “who”, “what”, “where”, “when”, “how”, etc.; key phrases might include e.g., “what can I do . . . ”, “what is . . . ”, “how much is . . . ”, “where did I . . . ”, etc. In other words, if speech-to-text translation of the user's prompt includes “what is . . . ” then a first set of pre-prompts are mapped, if the prompt includes “how much is . . . ” then a different set of pre-prompts may be mapped.

More generally, the term “map” and its linguistic derivatives refer to any logic that associates labels (e.g., inferred from user intent) to a set of elements (here, predefined prompt augmentations). While the foregoing examples are presented in the context of simple mappings, the concepts are broadly applicable to any association (including one-to-one, one-to-many, many-to-one, many-to-many, etc.). Additionally, while the foregoing example is presented in the context of a one-to-one look-up, more complex variants may use e.g., a reduced-complexity LLM or other text analysis logic to provide more complex associations.

In some cases, the LLM input specializer may also consider LLM-specific factors such as e.g., availability, latency, cost, etc. when augmenting the prompt. While the exemplary LLM input specializer may not directly launch the query (this may be performed by a query constructor described in greater detail below), the LLM input specializer may use LLM-specific information to change the amount of information and/or type of information provided to a query constructor. Furthermore, some variants may also allow the LLM input specializer to recommend a destination LLM to the query constructor. For example, an LLM input specializer may recognize the environment as a work environment and recommend a work-specific LLM (or otherwise topically-specific LLM). As another example, an LLM input specializer may recognize that the user appears to be referring to their own property (e.g., “where are my keys?”, etc.) and may infer that the prompt should be directed to the user-specific database. Still other user prompts may be qualitatively or quantitatively assessed for complexity; more complex prompts may require more sophisticated LLMs, simpler prompts may be more quickly (and inexpensively handled) with simple LLMs.

While the present discussion is described in the context of a single LLM input specializer, various implementations may use multiple LLM input specializers to further subdivide prompt augmentation. As but one such example, the smart glasses may include a first LLM input specializer that augments prompts based on its captured data, whereas the smart phone may have a second LLM input specializer that augments the prompt in view of persona data (described below). In some embodiments, multiple LLM input specializers may be parallelized and/or serialized. Parallelized processing may be important for reducing latency of multiple independent processing tasks; for example, where a user prompt may touch on multiple distinct topical areas or specialties (these data are unrelated and separate). Serialized processing may be useful for dependent tasks (e.g., topically, sequentially, and/or conditionally related). For example, a user may ask for suitable restaurants nearby (e.g., place/time information is dependent on personalization information). As another example, a user may ask for information about a specific hole on a golf course (e.g., both generalized information as well as user-specific notes from previous play (if any)).

As another important note, words/tokens and sensed data have significant differences in size. A large amount of sensed data may be condensed into only a few tokens; thus, input specialization that occurs at the smart glasses can greatly reduce the amount of data that needs to be sent to the smart phone. This directly corresponds to reduced processing, encoding, memory and power consumption on both devices, as well as any downstream processing. While the exemplary embodiments are discussed in the context of “words” and “text”, the concepts may be broadly extended to any user device that can capture data from its environment (e.g., images, sounds, symbols, gestures and other user interactions, etc.) and convert the data into tokens or other data structures natively used within a machine learning foundation model.

Furthermore, input specialization may be useful in a variety of other contexts. In other words, while LLM input specializers are designed to augment prompts with additional information in a natural language format, the mapping/association techniques described above can be readily adapted to other types of models (e.g., large multi-modal models (LMMs), foundation models, and/or other forms of generative intelligence). For example, a website input specializer may be used to map speech-to-text, images, and/or image-to-text over into generic website specific inputs and/or navigation. Similarly, a social network input specializer may be used to map speech-to-text, images, and/or image-to-text over to social network-based interactions.

At step 858, the edge device provides the instantaneous user context to another device. In some embodiments, user interest may also be provided.

In one embodiment, the edge device provides the instantaneous user context in real-time (or near real-time) as it is captured. In other embodiments, the edge device may provide the instantaneous user context at best-effort. In still other embodiments, the edge device may capture and store the instantaneous user context (along with timestamp information, if necessary) and provide the data in bulk, or offline. Instantaneous user context may be provided to an aggregator, cloud service, or other device. In some embodiments, instantaneous user context is “pushed” by the edge device. In other embodiments, instantaneous user context may be “pulled” by the other device. In yet other embodiments, the transfer may be coordinated according to e.g., scheduling and/or handshake transfer protocols.

### 5.2 Aggregation

Functionally, the aggregator device aggregates user context from one or more sources (e.g., instantaneous user context (location, images, audio, etc.), accumulated user context, and/or user interest, etc.) to enable multi-modal attention for interactions between the user and other network entities. In order to do so, the aggregator device may process user context to identify attention. For example, a smartphone may run a small LLM (or similar generative intelligence logic) to encode and/or decode input (the voice commands, image, etc.) in combination with computer-vision analysis to assess attention.

Notably, conventional LLMs use a single modality (text) and assume a single user for chatbot-like functionality. In contrast, the exemplary embodiments described throughout aggregate information from multiple different modalities of data. For example, a user may use verbal commands (asking: “summarize the Wikipedia article for this.”) in relation to visual information (a gaze point that identifies an object, “this”) when interacting with multiple different network resources (e.g., a text-based LLM and a conventional webpage “Wikipedia”, etc.).

As used herein, the term “attention” refers to the inferred importance of tokens from their usage in relation to other tokens. Tokens are not limited to inputs; e.g., output tokens are also fed back, such that that transformer can attend to them as well. As previously noted, LLM transformer models assign contextual information to tokens in order to calculate scores that reflect the importance of the token relative to the other tokens. Importantly, the contextual information is dynamically inferred, and is not merely a defined weight/score for the token in isolation. Conceptually, LLMs assess both the actual meaning of words as well as their importance in a sentence, relative to the other words of the sentence. More generally, however, any mechanism that performs a dynamic assessment of contextual information, relative to other contextual information, may be considered an attention model.

In some embodiments, the aggregator may provide an additional layer of access control over the user's edge devices and/or other personal data. For example, certain network entities (e.g., a LLM) may request supplemental user context to provide better results; other embodiments may allow network entities to request user context based on scheduling and/or other trigger events. These requests may be granted, denied, and/or routed via the aggregator device. Conceptually, this may be particularly useful where combinations of different modalities of data and/or accumulated data may have more significance than isolated data points. For example, a user surfing the internet on their phone may have two separate devices (smart glasses and smart phone) which are each anonymous in isolation, yet when combined may be used by a 3^{rd} party to identify the user's identity and other sensitive information.

Furthermore, the aggregator device may also manage a user profile associated with the user and select portions of instantaneous user context to accumulate (or discard) to create accumulated user context. The user profile and accumulated user context are used to augment interactions between the user and external data sources (e.g., large language models (LLMs) as well as the broader internet). The aggregator device also manages ongoing conversation state, which may be distinct from the session state of the LLM.

### 5.2.1 Implementation and Design Considerations

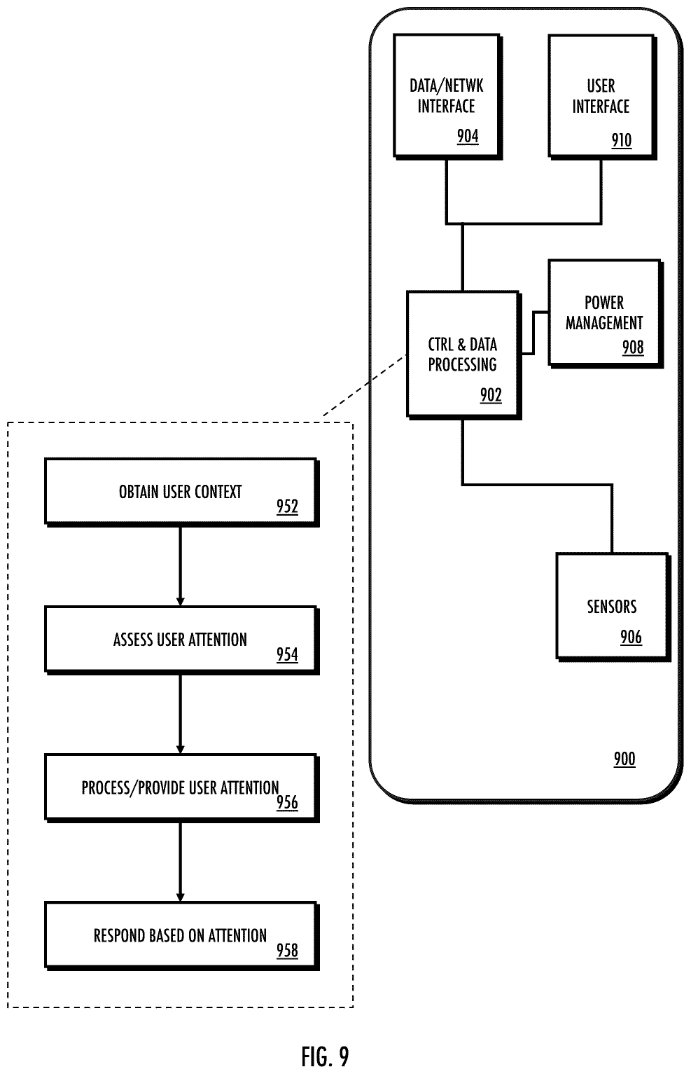

FIG. 9 is a logical block diagram of the exemplary aggregator device. The aggregator device includes: a control and data processing logic 902 and a data/network interface 904. The control and data processing logic 902 obtains data generated by the user, other devices, and/or captured from the environment, to perform calculations and/or data manipulations. The data/network interface 904 converts data for transmission to another device via removeable storage media or some other transmission medium.

Many implementations may also include a power management subsystem 906, a sensor subsystem 908, a user interface subsystem 910, and/or other peripherals. For example, a smart phone implementation may include its own cameras, microphones, touchscreen, batteries, etc. More generally, the aggregator device has many similarities in operation and implementation to the edge device which are not further discussed below; the following discussion provides a discussion of the internal operations, design considerations, and/or alternatives, that are specific to aggregator device operation.

Within the context of the aggregator device, the data/network interface subsystem enables communication between devices but may have additional functionality to support its aggregation functionality. For example, the aggregator device may have multiple network interfaces with different capabilities. Here, the different wireless technologies may have different capabilities in terms of bandwidth, power consumption, range, data rates (e.g., latency, throughput), error correction, etc. In one specific implementation, the aggregator device may communicate with one or more edge devices via a first network interface (e.g., a personal area network (PAN)) and the cloud service via a second network interface (e.g., a wireless local area network (WLAN)).

As a brief aside, Bluetooth is a widely used wireless protocol that is best suited for short-range communication, and data transfer between mobile devices. Bluetooth is typically used at low data transfer rates (below 2 Mbps), and often found on devices that require low power consumption. Bluetooth networks are typically small, point-to-point networks (e.g., typically <7 devices). In contrast, Wi-Fi may be configured with larger ranges (>100 m), significantly faster data rates (9.6 Gbps), and/or much larger network topologies. Wi-Fi consumes much more power and is generally used for high-bandwidth applications, etc.

Both Bluetooth and Wi-Fi use the ISM bands which are susceptible to unknown interferers; cellular connectivity often uses dedicated frequency resources (expensive), which provides significantly better performance at much lower power. Cellular modems are able to provide high throughput over very large distances (>¼ mi).

Low power network interfaces may enable a “wake-up” notification. A wake-up notification for a communication device is a signal or alert that prompts the device to transition from a low-power or sleep mode to an active state. This notification is typically used in scenarios where the device needs to conserve energy when not in use but remain responsive to incoming communications or events.

The process of a wake-up notification involves the device periodically checking for any incoming signals or messages, such as network packets or signals from other devices, while in a low-power state. When a wake-up notification is received, it triggers the device to “wake up” or transition to a fully operational state, allowing it to process the incoming data, respond to commands, or initiate actions as needed. For example, the aggregator device may receive a paging notification from the cloud service that requires information from a sleeping edge device. As another such example, an edge device that is monitoring for user interest may need to wake up the aggregator device.

As previously noted, the control and data processing logic controls the operation of a device and stores and processes data. Since the aggregator device may obtain and/or combine data from multiple sources (both edge devices and cloud services), the aggregator device may be appropriately scaled in size and/or complexity. For example, the aggregator device may have multi-core processors and/or high-level operating systems that implement multiple layers of real-time, near-real-time and/or best-effort task scheduling.

5.2.2 Attention from Multi-Modal User Content

As previously alluded to, the aggregator device 900 may provide aggregation functionality (aggregation stage 604 depicted within FIG. 6). Here, the aggregator device may infer attention from multiple different modalities of input. Some implementations may convert different modalities into a common modality (e.g., image-to-text, speech-to-text, and text are combined as text data); other implementations may directly convert each modality of data to tokens/embedding vectors for synthesis in higher order space. The following discussions present one such aggregation scheme.

As shown in FIG. 6, the aggregation stage 604 may obtain different modalities of user context from edge capture. In the illustrated example, the different modalities of user context are converted into a common modality (text).

Here, image-to-text logic 636 may use captioning logic to analyze visual data and generate a “label” (or caption). As but one such example, a convolutional neural network may analyze an image and identify objects (e.g., faces, scenes, etc.) using reverse image search. Reverse image search may use e.g., online libraries and/or localized variants (where local resources are available). The identified objects are bounded with bounding boxes and labeled. For example, an image of a dog licking a person might have a bounding box around the dog that is associated with the label “dog”, a bounding box around the person that is associated with the label “person”, and a bounding box around the dog licking the person with a label “dog licking person.” Depending on the level of specificity and user context, a user might be interested in the dog, the person, the interaction between dog and person, etc.

Some images may contain visual representations of, or references to, information. Here, the user context may incorporate not only the visual representation, but also extract the information that it represents/references. For example, images of text represent letters and words-optical character recognition (OCR) may be used to extract the text from the image. Similarly, human-readable signs may represent information visually (e.g., iconography, patterns, color, etc.). Thus, for instance, street signs and/or markings may be labeled with their meaning (rather than their description)—e.g., white-dashed markings on a roadway may be labeled as a lane that allows passing on one side, yellow-dashed markings on a roadway may be labeled as a lane that allows passing on both sides, etc. Machine-readable codes may encode information (e.g., bar codes, etc.) or reference the location of information (e.g., QR codes, etc.)—the extracted user context may display the URL and/or the content that the URL refers to.

In addition to image-to-text logic 636, speech-to-text logic 638 may analyze speech waveforms to generate a “label” (or caption). Speech-to-text (also referred to as automatic speech recognition) converts spoken language into written text using e.g., signal processing, neural networks, machine learning, etc. Typically, speech-to-text attempts to separate speech-like waveforms from background noise; the cleaned waveform is searched for phonemes (units of sound in a language) using e.g., mel-frequency cepstral coefficients, etc. The resulting phonemes are matched against an acoustic model to predict word-like structures and phrasing; some phonemes may also be corrected/inserted to compensate for noise, etc. Some words sound like other words or parts of words (e.g., homonyms, etc.), thus the word-like structures may be further disambiguated and corrected with language processing.

Other modalities of data may be further processed into text. For example, location information may be converted into location labels using geospatial information, time data may be converted into time labels. Motion may be used to infer certain types of activity (e.g., sitting, sleeping, walking, running, driving, etc.). In some cases, certain types of enumerated labels may be preferred or used in duplicate. For example, a time stamp may be used as both its actual time, as well as a rough time of day (morning, afternoon, evening, night, etc.). Similarly, geospatial coordinates may be kept exact and/or enumerated (home, work, gym, etc.). More generally, any conversion, incorporation, augmentation, and/or mapping may be substituted with equal success.

The user context is then logged (event logger 640) for stitching (described elsewhere) and provided to an LLM input specializer 642 for machine-generated prompt augmentation. Machine-generated prompt augmentation may be further informed by the persona data logic 644. In the illustrated embodiment, the LLM input specializer combines the various streams of information—for example, user input (e.g., speech, gestures, etc.) may be combined with other user context. User context may include both instantaneous user context (e.g., captured images, video, audio, motion, etc.) as well as persistent user context (e.g., persona, etc.).

Conceptually, the LLM input specializer 642 seeks to elaborate on user context by combining information sourced from different modalities. For example, a user may issue a voice command (audible instruction), in reference to something they are looking at (a region-of-interest). As another such example, a user may look at an object which is quickly identified according to a first layer of computer vision logic, and then more thoroughly examined with a second layer of computer vision logic. In addition to instantaneous user context, the LLM input specializer 642 may also obtain persistent user context via persona data logic 644. Persistent user context refers to user context that persists over time. In some cases, the persistent user context may have definite boundaries (e.g., a window having a start time and end time); in other cases, the persistent user context may be indefinite (e.g., the window may have an undefined start time or undefined end time). The persistent user context may be stitched together from logged events into a persona data logic 644.

In one specific implementation, a persona data logic 644 stores predictive associations for machine-generated prompt augmentation that have been inferred from user patterns. For example, a user that frequently visits a restaurant may have geo-spatial pre-prompts that include information gleaned from previous visits (e.g., previous orders, wait staff names and details, etc.). Similarly, a user that has a specific routine may obtain pre-prompts for schedule information (e.g., next task, history of tasks, etc.). In other words, persistent user context may be used in combination with instantaneous user context to draw trigger predictive behaviors based on spatio-temporal context, etc.

More generally, user context may be elaborated upon with additional processing, iterative processing, temporal/spatial relationships, and/or cross-collaborative processing. While the foregoing discussion is presented in the context of an LLM input specializer that performs aggregation using a common modality (text), other aggregation schemes may perform aggregation without this intermediate step directly within the higher order space (e.g., an image-based token and a text-based token may both map embedding vectors in the same space), etc.

In one exemplary embodiment, the control and data processing logic includes a non-transitory computer-readable medium that includes a routine that causes the aggregator device to: obtain user context (instantaneous user context, accumulated user context, and/or user interest), encode and/or decode the user context to assess attention, and access network resources based on the attention. In some variants, the attention may be used to interact with foundation models (e.g., large language models (LLMs) and/or other foundation models) and/or other network entities. In other variants, the attention may be used to store accumulated user context for later usage. The following discussion explores these steps in more detail.

At step 952, the aggregator device obtains user context. In one embodiment, the aggregator device is in communication with one or more edge devices to obtain instantaneous user context and/or user interest. The aggregator device may also be in communication with one or more cloud services accumulated user context and/or persona data.

In some topologies, the aggregator device may communicate with edge devices and/or the cloud services via the same network technology. In other topologies, the aggregator may communicate with edge devices and/or cloud services via different network technologies. Examples of network topologies may include e.g., Bluetooth (and other personal area networks (PANs)), Wi-Fi (and other local area networks (LANs)), cellular communications and/or satellite communications.

Different communication protocols may provide various degrees of efficiency and/or reliability. For example, most communication protocols specify a format and structure of the data being transmitted, including protocols for encoding, compression, and error detection/correction mechanisms. The communication protocol may also specify procedures for establishing and terminating communication sessions, such as handshaking protocols, connection setup, and teardown procedures. The communication protocol may also include provisions for flow control and congestion management to regulate the rate of data transmission and prevent network congestion. In some variants, the communication protocol may also specify encryption, authentication, and data integrity checks, etc. to protect sensitive information from unauthorized access or tampering during transmission. As but one such example, a Bluetooth link between and edge device and an aggregator may specify time slot, error handling, enumeration/sleep/wake procedures, and/or cryptographic key exchanges, etc.

Application Programming Interface (API) based communications are commonly used to integrate and interact between different entities, allowing them to leverage each other's functionalities and share data in a controlled and standardized manner. This may be particularly beneficial for mixed networks operation (e.g., aggregators may communicate with different edge devices and/or cloud services). Typically, API-based communications use a request/response protocol. During operation, a requesting system sends an API request, which includes specific parameters or instructions outlining the desired action or data retrieval. The receiving system processes the request based on the specified parameters and executes the corresponding actions (e.g., retrieving data from a database, performing calculations, or generating a response). Once the request is processed, the API sends a response back to the requesting system, containing the requested data or an acknowledgment of the completed action. As but one such example, a Wi-Fi link between and aggregator device and a cloud service may use an API-based protocol to transfer data.

As previously alluded to, any number of different signaling mechanisms may be used to obtain user context. User context may be “pushed” to the aggregator and/or “pulled” from another device. User context may be real-time, near real-time, and/or best-effort. Data may be transferred as-needed, on a scheduled basis, etc. For example, edge devices may push instantaneous user context to the aggregator according to real-time schedules, whereas the aggregator may pull accumulated user context from cloud services only as-needed.

While the aggregator typically obtains user context from other devices, it may also generate user context as well. In some cases, the aggregator device may capture data (e.g., a smart phone may obtain location data via GPS, etc.). In some cases, the aggregator device may accumulate data based on e.g., collected user context and/or other processing (e.g., offline stitching processes, etc.). In still other cases, the aggregator device may generate user context from its own aggregation processing, discussed below.

At step 954 and step 956, the aggregator device transforms (encodes and/or decodes) the user context to assess attention, and then process/provide access to network resources based on the attention. The aggregator may include “control path” logic that directs and coordinates the operations of the pipelined system. The control path generates the control signaling that determines the sequence of operations performed by the pipeline. The aggregator may also include “data path” logic responsible for manipulation and processing of data within the system. The data path performs tasks such as encoding/decoding to high dimensional space, high dimensional space operations, etc.

In some usage scenarios, user context may include a user generated prompt; e.g., the user may ask a question or issue a verbal instruction, etc. In other embodiments, the edge devices may have been monitoring the user, or another network entity may have requested (and been granted) access to the user context. Regardless of situation, the aggregator determines which portions of user context (possibly gathered across different modalities and/or sources) should be “attended” to. In other words, the aggregator device needs to identify which pieces of user context require attention.

As previously noted, transformers are a type of neural network architecture that “transforms” or changes an input sequence into an output sequence. They do this by learning context and tracking relationships between sequence components. In the context of a transformer model, “attention” refers to a mechanism that allows the model to focus on different parts of the input sequence when making predictions. The attention mechanism allows the model to weigh the importance of different words in the input sequence when generating an output sequence. A single-attention head computes attention scores between all pairs of words in the input sequence, determining how much each word should contribute to the representation of other words. Multi-headed attention captures different aspects of the input sequence simultaneously. Each attention head learns a different attention pattern, allowing the model to capture a more diverse range of relationships within the input sequence.

Within the context of the present disclosure, the aggregator device combines data from multiple data sources into an input sequence that can be processed within a transformer model. In one specific implementation, the input sequence is based on information gathered across different modalities of data. In addition to instantaneous user context, which is provided from edge devices, the aggregator may also retrieve accumulated user context based on previous user interactions, and/or user persona data (data that is specific to the user, but not derived through interactions). While the described implementations are presented in the context of a large language models (LLMs) transformer, the concepts could be readily adapted to large multi-modal models (LMMs) and/or other fundamental models.

In one embodiment, user context is converted into a common modality. For example, an LLM uses text as its common modality, thus other modalities may be converted to text. For example, images may be pre-processed with image-to-text, verbal input may be pre-processed with speech-to-text, and audio may be pre-processed with sound-to-text, etc. An image-to-text conversion may use captioning and object recognition algorithms to generate text descriptions of an image. For example, an exemplary image-to-text conversion may include pre-processing, feature extraction, conception, and then caption generation. Pre-processing performs e.g., resizing, normalization, and enhancing the image to improve its quality, and/or any other preparatory modifications for feature extraction. Feature extraction may use a convolutional neural network (CNNs) to extract high-level features that represent objects, shapes, textures, and spatial relationships within the image. The extracted features may then be provided to a language model to generate the caption; common language models include a Recurrent Neural Network (RNN), its variants like Long Short-Term Memory (LSTM), and/or Gated Recurrent Unit (GRU). Post-processing may be used to fit the resulting caption to an appropriate size and descriptiveness. Analogous techniques for speech-to-text and/or sound-to-text may be used with equal success.

In multi-modal embodiments, user context may be processed in their distinct modalities. For example, an LMM may be able to natively combine images, audio, and/or speech within a common framework. Depending on implementation, the LMM may generate an output sequence in natural human language; other implementations may use computer-parsed formats e.g., XML, JSON, or similar logical syntax.

As previously discussed, an edge device may have an input specializer(s) that pre-processes the input (e.g., provides suggested prompt augmentations). However, input specialization may occur with less than full contextual knowledge, and also may introduce irrelevant and/or redundant information. Thus, exemplary embodiments of the aggregator may refine and/or adjust the pre-processed input (user prompt) to construct contextually complete, consistent, and concise queries. This process is referred to throughout as “query construction.”

As used herein, the term “query” and its linguistic derivatives refers to the message that is sent to the destination resource. In some embodiments, the query could be provided in terms of text and/or words (e.g., the user's prompt along with any pre-prompt, mid-prompt, post-prompt, and/or modifiers, etc.). In such implementations, the destination would tokenize the query. However, in other embodiments, the query may be transmitted in the form of tokens/embedding vectors and/or other data structures natively used within a machine learning foundation model.

While the foregoing discussions are presented in the context of a single query that is constructed from a single user input for ease of illustration, query construction is not necessarily 1:1—any M:N mapping may be substituted with equal success. For example, complex user input may be sub-divided into multiple queries. Similarly, simple user input may be aggregated and/or combined with other user input. Here, the simplicity and/or complexity of the user input may be determined via length, subject matter, grammatical construction, multi-modality (verbal and image processing, etc.) and/or any other characteristic of the user input.

In one exemplary embodiment, the aggregator may receive a first set of capture-based prompt augmentations from a first LLM input specializer on a smart glasses and a second set of persona-based prompt augmentations from a second LLM input specializer on the smart phone. In this case, the first LLM input specializer may access a first layer of image-to-text that is reduced in size and/or complexity to operate within the design constraints of the smart glasses. The second LLM input specializer running on the smart phone has access to the user's persona data and may have more generous design constraints (more powerful processor, larger memory, higher thermal dissipation, etc.). Additionally, a second more capable layer of image-to-text may be run on e.g., the smart glasses (or smart phone) when requested, to provide more detailed labeling of the image.

In some cases, the aggregator may additionally determine that more information is needed, and iteratively refine prompt augmentation. Consider a user holding a bottle of soda pop; the first layer of image-to-text may identify the object as “soda”. Initially, this text label may be provided to the smart phone with the prompt augmentations from the capture-based prompt augmentations. While “soda” might be sufficient for a generic query, in this case, the user's persona may include preferred and/or non-preferred types of soda. For example, the persona-based LLM input specializer would have different associations if the “soda” is “Diet Cola” (preferred) versus “Root Beer” (non-preferred). Here, the persona-based LLM input specializer may instruct the second layer of image-to-text to disambiguate the bottle of soda. In one variant, the second layer of image-to-text is executed on the smart glasses, and the updated labels are provided to the smart phone. In other variants, the smart glasses provide the captured region-of-interest image data to the smart phone, and the second layer of image-to-text is executed from the smart phone. In still other variants, the smart phone may forward the region-of-interest to an external 3^{rd} party server for further analysis.

Multiple iterations may be used to refine information to virtually any arbitrary degree. For example, a “musical instrument” might be disambiguated into “guitar” in a first iteration. In a second iteration, the “guitar” might be classified as a “electric” or “acoustic”. In a third iteration, the acoustic guitar might be classified as a “6-string” or a “12-string”. In a fourth iteration, a picture of the 12-string acoustic guitar might be classified into brand and/or model information (e.g., Martin D12-28, etc.). Iterative refinement in this manner allows for sequentially more constrained classification tasks which can be performed only to the extent needed (rather than one monolithic classification task performed to completion).

In some cases, cached information may be retrieved and/or new information may be captured across multiple iterations (e.g., additional image captures and/or request clarifying input from the user, etc.). For example, the smart glasses might attempt to perform image-to-text but determine that a new capture is needed (better lighting conditions, etc.). As a related example, an LLM input specializer may determine that additional information is needed from the user; the user may be asked to clarify the prompt.

In some embodiments, different sensor captures may be iteratively launched for varying degrees of detail. Consider one implementation where a low-power “always-on” camera may be used in combination with a high-resolution camera to provide different types of data. Here, the always-on camera may monitor the external environment at very low resolution, very low frame rates, monochrome, etc. to reduce power consumption. The always-on camera may be used in this configuration to assist with auto exposure (AE) for the high-resolution camera; thus, allowing for much faster high-resolution captures. During operation, a set of inward-facing cameras may monitor the user's eye motions for gaze point (to determine user intent). When user intent is identified, the high-resolution camera capture is read out in the region-of-interest (ROI) for the user intent (e.g., reducing the field-of-view for power consumption reasons). In this case however, the low-power always-on camera already has image information in a higher field-of-view; this may be acceptable to get a better context of what is happening without providing a larger higher-resolution ROI. For example, a user may be looking at a table, in their living room (discernable from the always-on camera). The high-resolution ROI may be able to identify the object of interest e.g., key, book, etc. and in some cases may even be able to focus on fine details (text, OCR, etc.). Similar concepts may be extended to other types of media (e.g., high-sample rate snippets of a larger sound recording, etc.).

While the foregoing discussions are presented in the context of image-to-text and speech-to-text, virtually any classification and/or recognition logic may be used in combination with the foregoing. For example, some implementations may use e.g., optical character recognition (OCR) and/or reverse brand image search, etc.

In some cases, the aggregator device may have local private resources to e.g., respond to the user prompt and/or augmented query. However, the aggregator device may also have access to the broader Internet and/or other public databases. In many cases, the aggregator device may enable multi-modal attention for interactions between the user and other network entities. Local resources may be used to cache information for responding to user interactions that are e.g., frequent, sensitive, etc. External processing may be used to provide functionalities and/or features beyond the capabilities of the aggregator itself (discussed in greater detail below).

Referring back to FIG. 9, the aggregator device may respond based on its local processing or external processing of the multi-modal attention (step 958). In some embodiments, the response may be provided at the aggregator device (e.g., smart phone). In other embodiments, the response may be provided to an edge device (e.g., smart glasses) for presentation to the user. In some cases, the response may use the multi-modal attention to generate textual responses via an LLM. Still other implementations may provide the responses in the form of visual information (e.g., image recall), text-based messaging (e.g., text-based virtual assistant), audio playback (e.g., voice-based virtual assistant), webpages or other accessible network resources, and/or any other presentation mode.

### 5.3 Resource Selection

Functionally, the cloud services are used to allocate network resources (e.g., external network entities) for processing requests by, or on behalf of, the user. For example, some (but not all) user queries may be handled with an LLM; other queries may be more efficiently handled with information gleaned from webpages and/or user databases, etc. For reasons explained in greater detail below, appropriate resource allocation improves resource utilization (e.g., computational efficiency, memory footprint, network utilization, etc.). Notably, resource selection is distinct from the other benefits of cloud operation (e.g., offloading processing, memory, and/or power consumption onto other cloud compute resources).

Separately, cloud services may also be used to collect and process attention information from multiple individuals. So-called “group attention” may be particularly useful for social applications. For example, a group of individuals that is coordinating their activities may combine their individual contextual information (instantaneous user context, accumulated user context, user profiles, etc.) to generate group attention. Group attention may then be used to respond to user queries for the group as a whole. For example, a user dining with a group of friends could interact with an LLM that takes the dining preferences of the entire group into account.

As an important corollary, group attention is dynamically derived from a population of users. Unlike conventional schemes which place individuals into fixed groupings/categories (e.g., ethnicity, gender, interests, etc.), the exemplary group attention may be dynamically generated from any arbitrary collection of individuals-without exposing sensitive information about its individual members. This creates opportunities for unique uses; for example, group attention may be used by e.g., a restaurant to identify menu items that drew the attention of its patrons, and perhaps more importantly, its non-patrons (passerby's that could not find any palatable options).

### 5.3.1 Implementation and Design Considerations

Cloud services refer to software services that can be provided from remote data centers. Typically, datacenters include resources, a routing infrastructure, and network interfaces. The datacenter's resource subsystem may include its servers, storage, and scheduling/load balancing logic. The routing subsystem may be composed of switches and/or routers. The network interface may be a gateway that is in communication with the broader internet. The cloud service provides an application programming interface (API) that “virtualizes” the data center's resources into discrete units of server time, memory, space, etc. During operation, a client request services that cause the cloud service to instantiate e.g., an amount of compute time on a server within a memory footprint, which is used to handle the requested service.

Referring first to the resource management subsystem, the data center has a number of physical resources (e.g., servers, storage, etc.) that can be allocated to handle service requests. Here, a server refers to a computer system or software application that provides services, resources, or data to other computers, known as clients, over a network. In most modern cloud compute implementations, servers are distinct from storage—e.g., storage refers to a memory footprint that can be allocated to a service.

Within the context of the present disclosure, data center resources may refer to the type and/or number of processing cycles of a server, memory footprint of a disk, data of a network connection, etc. For example, a server may be defined with great specificity e.g., instruction set, processor speed, cores, cache size, pipeline length, etc. Alternatively, servers may be generalized to very gross parameters (e.g., a number of processing cycles, etc.). Similarly, storage may be requested at varying levels of specificity and/or generality (e.g., size, properties, performance (latency, throughput, error rates, etc.)). In some cases, bulk storage may be treated differently than on-chip cache (e.g., L1, L2, L3, etc.).

Referring now to the routing subsystem, this subsystem connects servers to clients and/or other servers via an interconnected network of switches, routers, gateways, etc. A switch is a network device that connects devices within a single network, such as a LAN. It uses medium access control (MAC) addresses to forward data only to the intended recipient device within the network (Layer 2). A router is a network device that connects multiple networks together and directs data packets between them. Routers typically operate at the network layer (Layer 3).

Lastly, the network interface may specify and/or configure the gateway operation. A gateway is a network device that acts as a bridge between different networks, enabling communication and data transfer between them. Gateways are particularly important when the networks use different protocols or architectures. While routers direct traffic within and between networks, gateways translate between different network protocols or architectures—a router that provides protocol translation or other services beyond simple routing may also be considered a gateway.

Generally, these physical resources are accessible under a variety of different configurations that are suited for different types of applications. For example, a data center might offer: infrastructure as a service (IaaS), platform as a service (PaaS), and software as a service (Saas). These classes of service provide to different levels of control/abstraction of the underlying resources. For example, IaaS might provide the most flexibility and control for cloud services, but this may require the cloud service account for and manage the underlying information technology infrastructure. In contrast, SaaS is most efficient where the client service imposes few (if any) requirements on the underlying hardware. IaaS and SaaS are at two ends of a spectrum, PaaS may provide some of the flexibility of IaaS, with some of the convenience of SaaS. As but one such example, a cloud service request for an IaaS might specify the underlying compute resource by processor, memory footprint, operating system, network setup (IP configuration), and/or application software. In contrast, a SaaS cloud service might only specify the source code for the application, etc.

Conceptually, cloud services access, reserve, and use physically remote computing resources (e.g., processing cycles, memory, data, applications, etc.) with different degrees of physical hardware and/or infrastructure management. Modern data centers handle many different cloud services from a myriad of different entities—it's not uncommon for data centers to have average utilizations north of 60% (which compares favorably to the average utilization (<1%) for dedicated servers infrastructures). Computational efficiencies are directly passed onto the cloud service as operational cost; in other words, cloud services are only charged for the resources that they request.

Cloud services are often leveraged to reduce the resource burden for embedded devices-processing intensive and/or best effort tasks can be handled in the cloud. However, efficient usage of cloud services often requires different design considerations from embedded devices. For example, cloud services benefit from careful resource allocation; over-allocation, under-allocation, and/or any other type of mis-allocation can be very inefficient (too much idle time, excessive resource churn, etc.). This is particularly problematic when scaled over multiple instances. In contrast, embedded devices are physically constrained and cannot be virtually scaled. Thus, embedded devices are often conservatively designed to match its e.g., most likely use cases, worst case use cases, etc. Embedded devices offer significant performance enhancements and/or security relative to cloud-based counterparts. For comparison, once configured, inter-data center communication is 10× slower than intra-data center communication, which is 10× slower than on-device communication.

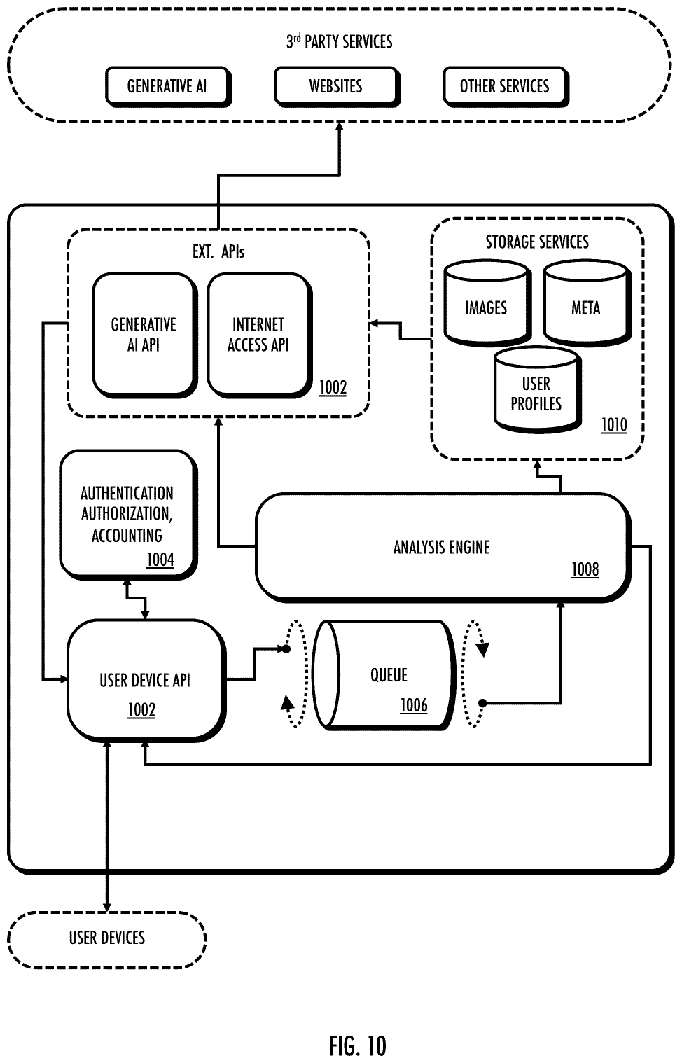

Due to the virtualized nature of cloud services, logical entities are often described in terms of their constituent services, rather than their physical implementation. FIG. 10 is a logical block diagram of intermediary cloud service 1000. The cloud service includes: one or more application programming interfaces (APIs) 1002, an Authentication, Authorization, and Accounting (AAA) server 1004, a scheduling queue 1006, an analysis engine 1008, and storage 1010. External resources may refer to any foundation models, websites, and/or other services.

An API (Application Programming Interface) is a set of rules and protocols that allows different software applications to communicate and interact with each other. It defines the methods, data formats, and conventions that enable access to, and functionality of, a software service, library, or platform. The illustrated implementation includes both device APIs and external APIs to interact with the other components of the system. The device APIs enable the aggregator device and/or the edge devices to communicate with the intermediary cloud service 1000, the external APIs are used by the intermediary cloud service 1000 to launch processing requests on external network entities. In the illustrated embodiment, the external API may additionally be bifurcated into generative AI APIs, as well as more conventional internet access APIs.

An Authentication, Authorization, and Accounting (AAA) server 1004 is a system that provides authentication, authorization, and accounting services for networked resources and services. The authentication component of an AAA server verifies the identity of users or entities attempting to access a system or resource. It validates the credentials provided by the user, such as usernames, passwords, digital certificates, or other authentication factors, to ensure their authenticity.

The authorization component determines what actions or resources a user or entity is allowed to access based on their authenticated identity and specific permissions. It defines the rules and policies that govern access control and ensures that users only have access to the resources they are authorized to use.

The accounting component of an AAA server tracks and records information about the usage and consumption of network resources. It collects data related to user activities, such as the duration of sessions, data transferred, and services accessed. This data can be used for billing, auditing, network monitoring, or generating reports on resource utilization.

Within the context of the present disclosure, the AAA server manages access control to cloud resources for both the users as well as the external network resources. For example, a user may need to authenticate their identity in order to access their data. Once authenticated, authorizations and accounting are checked to ensure that the user can e.g., perform a requested action, add new data, remove data, etc. Similarly, other users and/or external network resources may need to comply with authentication and/or authorization protocols. For example, a first user may want to access the user context of a second user for group attention-based applications. Similarly, an LLM or other network entity may request supplemental user context. Depending on the user's configured access control, these requests may be granted or denied (in whole or part). In some cases, default rules may be used for convenience. Some such variants may additionally provide user notifications and/or manual override options.

A scheduling queue 1006 manages and organizes tasks or processes that are waiting to be executed. The scheduling queue determines the order in which tasks are processed, ensuring efficient utilization of resources and adherence to specific policies or priorities. Typically, a scheduling queue uses a First-In-First-Out (FIFO). The FIFO may store a collection of tasks; the addition of new tasks takes place at one end, known as the “rear” or “tail,” and the removal of elements occurs from the other end, called the “front” or “head.” More generally, any data structure suitable for job scheduling, task management, event handling, and resource allocation, may be substituted with equal success. As but one such example, round robin queues may be used to ensure that tasks are scheduled equally (or according to some fairness metric). Priority queues and Multi-level queues may be used to schedule tasks according different prioritizations and/or categorizations. Shortest Job Next (SJN) (also referred to as Shortest Job First (SJF)) and Shortest Remaining Time (SRT) queuing are often used to reduce the average wait time. Earliest Deadline First (EDF) is commonly used in time constrained applications (e.g., real-time scheduling).

A storage 1010 is configured to structure and collect data in a manner that allows efficient storage, retrieval, and manipulation of information. Here, the illustrated implementation includes user context (instantaneous user context, accumulated user context, and/or user interest), user-specific images, user-specific metadata, and user profiles.

The storage 1010 organizes user-specific data according to any number of relational schemas. Common examples of such schemas may associate data according to user, modality, time, location, metadata (extracted features, etc.). Queries may be made against the database, according to authorizations and/or other access control restrictions. For example, a user may query the database for their own data at a first level of access (unrestricted) but may have a reduced second level of access to other user's data. Other databases may be substituted with equal success.

In some embodiments, the storage 1010 may be accessible via externalized APIs 1002. This may enable RAG-like libraries of user-specific data (discussed elsewhere). For example, the externalized APIs 1002 may allow an external network resource to access user-specific data, according to an authorization level. In some cases, this may be extended to multiple user access (e.g., a RAG-like library for a group of users, discussed elsewhere).

An analysis engine 1008 performs analysis on metadata or input (e.g., user context and/or user interactions) to extract meaningful insights, patterns, or conclusions. The analysis engine may be configured to perform: data ingestion, pre-processing, processing, and post-processing.

During data ingestion, the analysis engine receives data or input from various sources, such as databases, files, aggregator devices and/or edge devices. If pre-processing is necessary, then the analysis engine routes data to the appropriate network component for handling and/or parses data into its relevant components. For example, edge context may be archived and/or used to update cloud context. In other examples, user input may be pre-formatted for use with e.g., an LLM-based chatbot. Some variants may additionally identify and retrieve related contextual data for initialization data.

In some variants, the analysis engine 1008 may also perform processing of the task itself. For example, some implementations may incorporate a local LLM-based chatbot. Other tasks that can be readily performed may include data retrieval, data storage, and/or other data management of the storage 1010. Some tasks may offload processing to external 3^{rd} parties via API interfaces.

Once processing has completed, results may be presented to the user. While the disclosed embodiments describe a messaging type interface, other interfaces may be substituted with equal success. Presentation may be handled at the aggregator and/or edge devices (discussed elsewhere).

Referring back to the externalized APIs 1002 of FIG. 10, conventional internet access APIs may be based on a server endpoint that supports one or more client endpoints. Generally, the server endpoint has a URL (which translates to an IP address) to send and receive requests and responses. Clients send and receive using HTTP methods e.g., GET, POST, PUT, DELETE. The responses are usually provided in computer-parsed formats (e.g., JSON, XML, etc.). The server and client endpoints may additionally support authentication and authorization, rate limiting, and error handling protocols. Artisans of ordinary skill in the related arts will readily appreciate that the server and client may coordinate via complementary function calls to implement very sophisticated logical interactions over the underlying API framework.

LLMs (and other generative intelligence) typically use conventional APIs to accept input text (user queries, prompts, and text passages) and provide output text (e.g., the transformed output). More recently, so-called Retrieval-Augmented Generation (RAG) LLMs have combined retrieval-based APIs with LLM functionality. A RAG-based LLM allows a client to provide a query along with a relevant library (e.g., documents or pieces of information from a predefined dataset or knowledge base). The RAG-based LLM uses the library to generate a response. In particular, a RAG-based LLM may obtain the entire library, filter/rank the library contents based on the query, and then combine the filtered documents to the LLM as contextual information to answer the query. Existing RAG-based LLMs are primarily directed to avoiding hallucinations. In other words, RAG-based LLMs are focused on providing the LLM with access to databases of pre-verified information, such that the resulting LLM output is truthful and contextually appropriate.

Various embodiments of the present disclosure combine RAG-like libraries of user-specific data to LLMs. In particular, instead of identifying publicly accessible network resources for retrieval augmented generation, the exemplary API provides user-specific media, metadata, and user context for the LLM as context to answer from. Providing user-specific information to an external LLM introduces multiple challenges. First, security and privacy are needed to safeguard sensitive user information. Second, only a portion of the user-specific information may be relevant-to and/or authorized-for the query—reducing the amount of extraneous information reduces downstream processing. Thirdly, LLMs are capable of transforming existing data structures into new data structures having different characteristics—this may be used to generate information from the individual user domain into a group user domain and vice versa.

The following discussions explore these aspects of the exemplary user-specific generative intelligence system in greater detail.

### 5.3.2 Resource Selection and Session Management

Intermediary cloud service 1000 may provide resource selection and/or session management functionality (resource selection stage 606 depicted within FIG. 6). Notably, the resource selection stage 606, when used in combination with the edge capture stage 602 and aggregation stage 604, can select between different resources based on relevant user context (instantaneous and/or persistent). Conceptually, the pipeline infers user intent and selects appropriate resources according to what the user is likely seeing, feeling, hearing, etc.—and can predictively react based on the user's previous patterns (persona).

Here, query constructor logic 648 may identify the appropriate network resources that are needed to service the user's prompt and/or predictively prepare for the user's likely future activities. Different network resources may have different capabilities and/or restrictions, thus the query constructor logic 648 may construct its queries based on the constraints of the network resources. For example, a query constructor may limit the distribution of sensitive personal information. As another example, a query constructor may send more information to a more capable network resource, and less information to a less capable network resource. Similarly, a query constructor may evaluate the responses for sufficiency (e.g., does the response satisfy the query, etc.). Where necessary, the query constructor may iteratively add, prune, refine, and/or augment queries and their respective sessions as needed. In other words, the query constructor independently selects and evaluates information distinct from the user.

Independent selection and adjustment to service user requests and/or anticipate user may be more broadly characterized as “agentic” behavior. As used herein, the term “agentic” refers to entities that behave with their own agency (as opposed to another's agency). Agentic entities are distinct from conventional software “agents” which act on behalf of, and are controlled by, a user. For example, agentic resource selection may independently determine an amount of information to provide to one or more resources and/or whether a resource's output is acceptable for presentation to a user. One such mechanism for agentic decision may be based on soft max evaluation scores (discussed below). Notably, the decision mechanism is distinct from, and may even be hidden to, the user and the network resource since the agentic entity is an independent decision-making node.

In some embodiments, the aggregator and/or edge devices may provide user context and/or attention to the cloud service for processing. For example, the aggregator may provide multi-modal user context and its corresponding aggregated attention for a “virtual assistant” application. In other embodiments, the aggregator and/or edge devices may directly perform resource selection and use the cloud service as a helpful intermediary (e.g., for session management, additional resources, etc.). More generally, the following discussion is presented in the context of resource selection and session management at the intermediary cloud services based on e.g., available resources, security, privacy, and/or any number of other differentiating characteristics, however the concepts may be broadly applicable to resource selection/session management by any logical entity.

As a brief aside, LLMs widely vary in capabilities and function. While it is true that larger (and more expensive) models generally outperform smaller (less expensive models), there are many other important considerations. Some LLMs may have access to topical knowledge (e.g., LLMs that have been trained for specific topics or tasks)—these LLMs do far better in their narrowed field (e.g., medical, scientific, etc.), but are not suitable for general use. Other LLMs may have fast response times, larger token limits, handle complicated grammatical structures, etc. In some cases, an LLM may not even be the ideal source of information e.g., a user may just want the direct internet resource or local search result. In other words, selecting the correct LM or other resource may be a critical decision. For example, a research scientist user may use a topically-specific LLM to assist in answering quick questions, yet that same user might “change hats” and need to do grocery shopping after work, a task better suited for a different general-purpose LLM. A work-related prompt does not need ancillary information about the user's dietary preferences, and vice versa.

In one specific implementation, resource selection uses LLM-like logical components to perform destination selection. For example, much like an LLM, a query constructor may include an encoder that accepts text or token-based input. The results are fed to a decoder; however, the decoder is not trained to provide text output; instead, the decoder provides softmax values for different destination resources. In other words, rather than trying to predict the next word in the sentence, the query constructor attempts to predict the resource that is able to answer the query. Since most implementations will only select between a few candidate destinations (rather than a full lexicon of spoken language), destination selection can be performed on e.g., a smart phone or intermediary cloud service with minimal multi-head attention model and soft max selection logic.

A softmax score above a cut-off threshold indicates that a resource is suitable. A so-called “indeterminate” selection occurs where no destination exceeds the minimum cut-off threshold. In other words, more information may be needed in order to identify a suitable resource. In some cases, indeterminate values may trigger iterative prompt refinement (discussed above)—the user may be asked to clarify their request, additional information may be retrieved from the user device, etc. In some implementations, a default destination resource may be used for indeterminate values; this may be useful where a user may want to send a request for a fast response (e.g., relying on the downstream LLM to resolve the ambiguities).

A so-called “ambivalent” selection occurs where multiple destinations exceed the minimum cut-off threshold. In some variants, the highest scoring resource is selected as the destination resource. In other variants, multiple requests may be sequentially or simultaneously launched (as discussed in greater detail below) for any of the suitable resources. In still other variants, the results may be iteratively refined until a single resource is identified.

While the foregoing discussion describes an LLM-like logic that can process words/tokens to identify the destination resource, virtually any scoring and/or decision logic configured to select a destination resource based on a user generated prompt, machine generated prompt augmentations, and/or accumulated personalization data may be substituted with equal success. In some embodiments, the scoring and/or decision logic determines the relative complexity of the desired query (e.g., whether a search is easy or hard, etc.); the query may be modified to fit the destination, or the destination may be changed based on the query complexity. As another such example, the scoring and/or decision logic may consider whether the information is user-specific (or local) or generalized. User specific queries (e.g., “Where are my keys”) may be transmitted to a user-specific database for processing whereas generalized queries may be directed to other internet resources. Still other implementations may use topical information to determine whether the query should go to a topically-specific LLM or a general-purpose LLM. Here, topically-specific queries may be recognized through the usage of topically-relevant tokens; in other words, some LLMs recognize unique tokens (and/or combinations of tokens) that other LLMs do not.

While the foregoing discussion is presented in the context of text-based queries, the concepts may be broadly applied to large multi-modal models. For example, such implementations may use components akin to a large multi-modal model (LMM). In such implementations, the LMM-like resource selection logic may directly access region-of-interest (ROI) data and/or comprehensive image data; this may be important where the destination network resources are tasked to operate on image data. Similarly, other implementations may allow the LMM-like resource selection logic to directly access recorded audio waveforms, location and/or IMU data, etc.

As previously alluded to, resource selection may be based on a large number of potential prompt augmentations based on e.g., captured images, user instructions, and persona data-however, these suggestions may have been based on partial information and/or may have been made without knowledge of the destination resource. While iterative refinement may be used to obtain more information, the LLM-like resource selector logic (e.g., query constructor and/or intermediary cloud service) may also need to prune away redundant/unnecessary information. In other words, once the destination resource(s) are selected, the unnecessary portions of the query which do not appear to affect the desired response may be pruned away to reduce downstream processing. Prompt augmentations that appear to significantly overlap other prompt augmentations may be removed in whole, or combined together, to remove redundant portions. For example, a capture-based pre-prompt might be: “I am holding spinach” and a personality-based pre-prompt might be: “I am vegetarian”—while the vegetarian information might be useful in some contexts, within this specific context it may be redundant and can be removed.

As a related consideration, the positional encoding varies across LLM implementations. In other words, different LLMs may weight the information of various portions of a query differently. Thus, the LLM-like resource selector logic may modify prompt augmentation in view of the positional encoding of the destination LLM. For example, consider a destination LLM that prioritizes information at the start and end of a query over information in the middle. While the LLM input specializers may conservatively provide multiple options for positionally encoding a specific piece of information (a pre-prompt, mid-prompt, and post-prompt), the LLM-like resource selector logic may only include the option that corresponds to the importance of the information. Here, important information might be placed in a pre-prompt, background information might be provided in the mid-prompt, etc.

In some embodiments, session management logic (e.g., query constructor and/or intermediary cloud service) may separately store the state of the user's conversation. Here, the conversation state is locally stored and distinct from the destination LLM's session state (or context window); in other words, the conversation state may persist over many conversations and/or may have much larger (potentially limitless) token limits. Conversation state can be used to refresh and/or re-initiate a conversation with a destination LLM such that the conversation remains coherent to the user. When the token limit for the destination LLM is exceeded, the session management logic may selectively include or even re-insert prompt augmentations which ensure that the relevant tokens are present.

Furthermore, sometimes the LLM session state may time-out from disuse. Here, the session management logic (e.g., query constructor and/or intermediary cloud service) can resurrect the previous LLM session state by pre-emptively sending pre-prompts to establish critical details that the user is interested in. Consider, for example, a user that asked “What can I cook with this ingredient?” at the grocery store. They bought the ingredient and returned home. In the intervening time, their previous LLM session may have timed out. Here, the session management logic may reconstruct the previous conversation, so that when the user asks, “can I add this spice to the recipe?” the question is answered in the context of the same recipe that they were shown at the grocery store.

Decoupling conversational state from session state allows a LLM to seamlessly pick up a conversation, either from a previous conversation, or in some cases, from another LLM. In one specific implementation, the session management logic may independently track the user's conversational state. In simple implementations, this may be a stored text record of a running dialogue between the user and the glasses; the dialogue may then be used to generate prompt augmentations to bring the LLM up to the current conversational state. Some LLMs may directly expose session state (or context window) information via an API (application programming interface) or similar communication protocol; in such implementations, the session management logic may request session state and/or prime the session state via the API.

While the foregoing discussion is described in the context of a user-initiated process, the concepts may be broadly extended to machine-initiated processes as well. As but one such example, the session management logic may pre-emptively launch LLM queries based on image-to-text (or speech-to-text, IMU, etc.) input that is captured from the smart glasses. This may be useful to keep the session management logic up to date on the user's environment, activities, etc. Consider, for example, a smart phone that is tracking the user's location in the background during their day-to-day activities; when a user appears to be in an important location (e.g., based on persona data, etc.), the session management logic may pre-emptively trigger an image capture of the user's gaze point and send LLM queries to e.g., prime the conversation state with information about the user's environment. These initial LLM queries may be performed before the user has said anything (before speech-to-text) and may even be discarded if not useful. However, priming inquiries may provide a much broader basis of information and, if performed in advance and cached, will not add to response latency. In other words, priming may provide a contextually-aware (nearly prescient) user experience.

As previously alluded to, the session management logic (e.g., aggregator and/or the intermediary cloud service) may decouple the user's conversation state from the external resource's session state. This flexibility allows the session management logic to launch multiple queries to multiple destination resources and select only the most suitable results. For example, a user may have an ongoing conversation that is drawn from the output of multiple LLMs (i.e., where each LLM only contributes to a portion of the conversation).

Conceptually, the LLM's session state (context window) defines the text sequence that is used to generate the response. The LLMs own responses form part of the context window; this is needed so that the LLM remains self-consistent. However, in a multi-session conversation, none of the LLMs have a complete version of the conversation. Instead, the session management logic manages the conversation state and disseminates information to the destination LLMs as needed.

In some embodiments, the queries are constructed (“primed”) so that the LLMs' session state (context window) matches the relevant portion of the conversation state. For example, the relevant portions of the conversation state may be based on recency. In one such implementation, an LLM with a token limit of 4096 might only need the 4096 most recent tokens of the user's conversation state. More complex implementations may consider the user's input and/or surroundings (e.g., relevant subject matter, region-of-interest, gaze point, etc.). For example, the session management logic might filter conversation state based on what the user is talking about and/or looking at. More generally, any information that corresponds to the user's state of mind and/or intent may be used to select the most relevant portions of the conversation state with equal success.

Different LLMs have different token limits, knowledge bases, and/or training and may need different portions of conversation state. For example, a large LLM may receive much more conversational state (e.g., 16K tokens) versus a small LLM or small language model (SLM) (e.g., 4K tokens), etc. Furthermore, different LLMs have different tokenization and/or respond to different types of prompt engineering. In other words, the session management logic may need to separately fashion different queries based on each LLM's capabilities.

In some implementations, resource selection logic and session management logic may coordinate operation. This may be useful where multiple sessions are used to generate responses. Here, the session management logic selects one response from the received responses for presentation to the user. The selection criteria from the session management logic's response selection (e.g., softmax values, confidence values, etc.) may be fed back to the resource selection logic to assist and/or improve in the next resource selection.

Multiple parallel sessions may be used to combine the capabilities of multiple LLMs to optimize for the user's experience rather than the LLMs own considerations. In other words, the user experiences fast responses for simple questions, while also benefitting from in-depth answers where necessary. Selection may be based on a variety of criteria e.g., response time, response length, response quality, etc. As but one such example, multiple queries may be launched to models of different complexity; while a simple model can answer more quickly, the complex model may answer more accurately. Here, the first response that sufficiently answers the query is used. As another such example, multiple queries may be launched to LLMs with access to different libraries of information. The most comprehensive response (that is not a hallucination) may be used.

The session management logic updates its conversation state and presents the selected response. As previously noted, the conversation state is updated based on only the selected response and its corresponding query; the unused responses and queries are discarded. In simple embodiments, conversation state may be stored as a text dialogue. In other implementations, the conversation state may be represented as a set of tokens, embedding vectors, and/or any other representation of the conversation state. Since conversation state is internally managed by the session management logic, the user does not see the other responses.

### 5.3.3 Persona Stitching

Intermediary cloud service 1000 may also periodically “stitch” user context into a “persona” (see e.g., stitcher 650 depicted within FIG. 6); the persona may be further used to further refine prompt augmentation, etc. Conceptually, edge devices have access to many different modalities of user context (e.g., smart glasses may capture images and audio, smart phones may capture online interactions and location information), however they are often constrained by their available resources. The cloud service has access to nearly unlimited computational power and memory—this may be particularly important for computationally intensive stitching discussed below.

While the following discussion is presented in the context of a cloud-based “stitcher”, any device with sufficient resources may be substituted with equal success. For example, stitching could be performed via server, personal computer, laptop, etc. Furthermore, artisans of ordinary skill in the related arts will readily appreciate that technology continues to improve such that future technologies may perform stitching in form factors that are currently infeasible (e.g., smart watch, smart glasses, etc.).

As used herein, the term “persona” refers to a body of history-based user-specific information that enables the machine-generated prompt augmentation, LLM-selection, and/or other modifications of the control and/or data path for natural language processing. Persona information is not based on the user's words, gaze, or other sensed environment, but is retrieved from e.g., a user-specific database, cloud archival, etc. In one embodiment, the persona data structure maps user-specific relationships between tokens/embedding vectors of the foundation model. Persona dynamically changes as newly observed data points constructively/destructively reinforce previously identified relationships. New relationships may also be created from observed patterns of behavior.

Persona may be used to vary responses in many different ways. Different people asking the same prompt may receive different results due to differences in their personas. For example, a cinephile that asks for movie recommendations should receive more targeted recommendations for their tastes and also may prefer a richer set of information about the movies in comparison to a casual filmgoer. In some cases, the same user may want to receive different responses for similar queries, based on different contextual environments/times, etc. For instance, a user that asks for restaurant suggestions at work (e.g., convenience, networking opportunities, etc.) may have a different purpose than suggestions at home (e.g., healthy, kid-friendly, etc.). Still further, a person focusing their intent on different items of interest (targets) should receive different responses based on their relationship to those objects. For instance, a user's questions about a brand-new car (versus their owned car) are likely to be quite different.

In one specific embodiment, persona information may be cumulatively updated with user activity. Initially, persona might include basic personal information e.g., name, age, gender, home address, work address, schedule, social connections, and their corresponding details (e.g., family, friends, co-workers, etc.); this may be provided directly by the user via an intake questionnaire and/or scraped from existing data, calendars, and/or social media, etc. In one such embodiment, a virtual assistant software can ask questions to learn about a user's preferences based on certain triggering events. For example, after visiting a restaurant, the virtual assistant may ask: “How did this meal compare to the last one at Restaurant A?” and/or “What rating would you give this meal?”, etc.

Over time, the user's edge devices accumulate a broad spectrum of data during day-to-day activities (e.g., images captured over time, region-of-interest and gaze mapping information, vocal prompts, etc.). In addition to smart glasses data, the smart phone may also record daily travel, patterns of use, current interests, social networking activity, communications, etc. The physical and virtual activity of the user is then “stitched” into the persona information. In some cases, persona information may also be manually added to, removed from, and/or otherwise edited by the user (if desired) so as to further improve user experience.

As used herein, the term “stitching” (or “dreaming”) and their linguistic derivatives refers to the process of creating new relationships (and/or fitting existing relationships) to newly observed data within the high dimensional space of a foundation model framework. This enables high dimensional connections within the foundation model framework beyond the newly observed data points. For example, consider a person that regularly commutes between 8 AM-9 AM and 5 PM-6 PM; these time ranges may be labeled as “commute”. Labeling in the natural language format inherits the full descriptive richness of the tokens/embedding vectors of the foundation model; e.g., the tokens/embedding vectors for “commute” are additionally related to “work”, “keys”, “car”, etc. in high dimensional space. Thus, for example, “where did I use my keys last?” could result in the response “you used your keys for your commute.”

In one specific variant, accumulated data from the smart glasses and/or smart phone is periodically stitched to identify temporal, spatial, and/or activity patterns of the user across the day. When compared across days, the stitching may establish patterns of a user's daily routine. The daily patterns and/or routines may be described in text and converted to tokens. Importantly, certain salient user interactions (e.g., gaze point information and/or user generated prompts) and/or machine responses are already converted to tokens as a part of the LLM query-response interaction—these transactions may be stitched “as-is” from cached history data.

As but one such example, the stitching process may include pattern recognition over the previously used tokens/embedding vectors accumulated throughout the user's day-to-day activities. For example, image-to-text may be used to convert images into labels; these labels are then converted to tokens/embedding vector, etc. Similarly, labels and tokens/embedding vectors from vocal instructions and other forms of activity data (e.g., calendar data, physical location history, browsing history, health, and activity monitoring data, etc.) may be collected. These label data and tokens/embedding vectors are then correlated between each other to identify repetitive user patterns based on time, location, activity, etc. The resulting candidate matches are used to reinforce the existing associations (if any) in the user's persona, or to create new associations.

For example, consider a user that likes to hear news articles during their commute. Initially, they ask for news articles during their commute, and repeat this pattern over a few days. This pattern is captured as a user-specific routine. Later, during offline stitching, the “commute” label for this user may be associated with the user's news article preferences, etc. As a result, future queries may detect that the user is about to start their commute, and pre-emptively download suitable news articles. Importantly, this connection (which likely did not exist before) is inferred from user-specific patterns in high dimensional space—e.g., “commute” and “news” are typically not linguistically related. Different user's might use their commute time differently e.g., to check email, plan their to-do list, shop for clothes, play games, etc. In other words, this is a personalization learned through observed user activities (not searched for among sets of archetypes).

As another such example, a user may have a regular morning routine. The user might e.g., wake up, have a light meal, do some calisthenics, get dressed, meditate, and leave for work. This pattern is captured as another user-specific routine. Later, during offline stitching, the labels for these activities are stitched together. Once in a while, the user may be interrupted during their routine—the user may then ask, or be proactively prompted, to resume their normal routine. Again, it is important to emphasize that this personalization is stitched together over time from observations of the user's activity.

There are conventional technologies that already mine user data for data connections, however many of these techniques are focused on fitting the user according to a predefined set of criteria or a predefined tranche of similar users (e.g., mining user data to provide advertising relevancy, etc.). While this provides the most straightforward and efficient mapping of a user against known archetypes (such as marketing demographics), it is intractable for arbitrary connections between all possible words. In other words, these techniques require searching against a known search space; larger search spaces result in exponentially growing complexity.

In contrast, the exemplary techniques grow user-specific associations from observed data points, according to the embedding vectors of the high dimensional space. Connections are observed as they occur and stitched as a background process; this does not require a “search” process. This technique for stitching new relationships into an existing high dimensional space is much more tractable for consumer electronics.

In one specific implementation, the strength of association may be based on repetition. For example, associations may be recently adopted, short term, long term, habitual, etc. Habitual associations may be the most strongly weighted. In some cases, the user may have the ability to reset some or all of their identified associations. This may be particularly useful where a change drastically affects previously established behavior. For example, moving to a new home might change a previously habitual commute pattern; a hard reset allows the user to re-establish a new commute pattern without being bothered by irrelevant old commute patterns. More generally, however, strength of association may be based on a variety of factors e.g., emotional state, social reinforcement, user preference, device considerations, etc.

While the present disclosure is discussed in the context of a single persona for a user, the various techniques could be broadly extended to multiple personas for a single person. For example, a person might want to separate their work persona from their home persona, etc. Such a division may be useful to explicitly silo certain types of user activities and/or preferences, etc. Furthermore, while the following discussion is presented in the context of a single user, the concepts may be broadly applied to groups of users. For example, friends at a restaurant ordering multiple dishes to share might create a group persona that reflects the aggregated preferences of the friends as a whole.

### 5.3.4 Group Attention for Social Applications

In some embodiments, the analysis engine may be used to assess user requests within the context of social applications. Here, the analysis engine may include a non-transitory computer-readable medium that includes a routine that causes the cloud service to: obtain a user request and multiple user context, encode and/or decode the user request and multiple user context to assess group attention, and access network resources based on the group attention.

As a brief aside, attention in LLM-based chatbots are typically derived from sentences of a single user. However, the mixed modality inputs described above may be more broadly extended to multiple users. By combining user context from multiple users, a transformer can synthesize “group attention”. Since the focus is on the overall patterns and trends within the group data rather than on specific individuals, group attention aggregates data from multiple users unidirectionally—the individual user's context data cannot be reversed back out. More directly, depending on the group size and diversity, this may impart a loose form of anonymity. In other words, group attention may focus attention insights from the collective behavior of the group, while maintaining the privacy and anonymity of each user's input.

First, the cloud service may obtain a set of users. Consider a scenario where multiple users are trying to pick a restaurant to eat at. Each of the users may have their own likes and/or dislikes, however it may be inconvenient and/or infeasible to enumerate everyone's preferences. Here, a temporary “group” may be created that identifies the users as “members” of the group and their relevant access control.

Different members of the group may independently control the group's access to their information. Some members may want the group selections incorporated with their individual preferences, whereas others may only want their preferences reflected in the group selection but discarded after use. The users may have default settings for collaboration and/or sharing. Users may also have notification settings to alert them when their information is being used for a group, application, and/or other contextual information.

The group itself may also independently control access to its data. For example, a group administrator may identify members that have increased privileges (e.g., an administrator may have the ability to add, remove, and/or modify members, etc.). Certain members of the group may have prioritization over others (e.g., a celebration may want to ensure that one guest's preferences are prioritized over others, etc.).

Alternatively, the group may obtain information from its members. For example, the group may retrieve persona information to generate a group persona. In other cases, the users may push their information to the group. Push based embodiments may be particularly useful where the users may want to individually control what is provided to the group.

Once the cloud service has obtained the relevant member personas, the cloud service generates a group persona that reflects the member's aggregated characteristics. In some cases, the group persona may reconcile differences between the members (e.g., price point preferences), in other cases the group persona may preserve distinct characteristics (e.g., vegan, vegetarian, pescetarian, etc.). This information may be used to e.g., seed an LLM-based chatbot for a virtual assistant.

Once the cloud service has both group persona and group context, the cloud service encodes and/or decodes the group context to assess group attention. In one embodiment, much like aggregation of single user context, group attention may use an LLM, LMM, or similar foundation model to process the member context. Within the context of the present disclosure, the cloud service combines data from multiple members into an input sequence that can be processed within a transformer model. In one specific implementation, the input sequence is based on information gathered across different members.

In one embodiment, member context is converted into a common modality. Alternatively, multi-modal embodiments may process member context in their distinct modalities. Similarly, the aforementioned concepts of input specialization and query construction may be readily adapted. For example, each member may provide some pre-canned information using an input specializer (e.g., this member is a vegetarian), whereas the group-based query constructor may reduce and/or remove redundant information (e.g., all members are vegetarian).

In some cases, the cloud service may additionally determine that more information is needed and launch conversations to individual members to iteratively refine the results. For example, the cloud service may provide a list of options, and ask each user to rate their most preferred options, etc. Multiple iterations may be used to refine information to virtually any arbitrary degree. Iterative refinement may also enable sequentially constrained classification tasks which can be performed only to the extent needed (rather than one monolithic classification task performed to completion).

In some cases, the cloud service may perform analysis using its analysis engine. In other cases, the cloud service may externalize this functionality to another network resource. Here, the cloud service may provide access to its stored user-specific information for RAG-like interactions.

While the foregoing examples are presented in the context of an explicitly defined membership (e.g., a group that is joined by users and/or that is created by an administrator), these concepts may be further extended to applications where the membership is implicitly defined, or even nascent (yet-to-be-defined). For example, most user-facing social applications enable users to associate with one another (e.g., meetup, dating, etc.). However, anecdotal evidence suggests that privacy concerns and categorization filtering results often hide underlying patterns in these same social networking mechanisms.

As previously noted, group attention (and/or group features) may be mined wholly separate (and anonymously) from the underlying user-specific data. In other words, group attention is a unidirectionally derived form of data which cannot be traced back to its constituent data. Furthermore, passively gathered user context (i.e., user context which is not a product of user expression) lacks subjective meaning and can be used objectively for e.g., feature extraction, transformations, etc.

Consider, for example, a crop blight scenario that is independently observed by many different farmers. Conventional solutions would limit communication between farmers to their social circles and/or attempt to group the farmer based on known categories (e.g., other farmers having the same crops, neighboring farmers planting different crops, etc.). Yet conventional mechanisms might not have access to farmers that had independently observed the same symptoms but failed to report it. Similarly, farmers may have misreported similar blight resulting in misclassification. In contrast, the passive observations by edge devices of many farmers, may, when combined result in an implicit group attention of farmers to crop blight. This may be monitored by an agency to anticipate crop blight.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
storing a first mapping of a first set of token identifiers to a first set of embedding vectors, where the first mapping is based on a training library;
providing an application programming interface, the application programming interface configured to accept application programming interface instructions; and
responsive to receiving a first application programming interface instruction, defining a custom second mapping of a second token identifier to a second embedding vector.

2. The method of claim 1, where the second embedding vector is generated based on the first set of embedding vectors.

3. The method of claim 2, where the second embedding vector comprises a combination of a selected subset of the first set of embedding vectors.

4. The method of claim 1, where the second token identifier comprises a tradename or fanciful phrase.

5. The method of claim 1, where the second token identifier comprises a user-specific token identifier.

6. The method of claim 5, where the user-specific token identifier is based on a user-specific frequency of use or a user-specific meaning.

7. The method of claim 5, where the user-specific token identifier is based on a machine-generated prompt augmentation.

8. A method, comprising:
storing a first mapping of a first set of token identifiers to a first set of embedding vectors, where the first mapping is based on a training library;
responsive to receiving tokens from the first set of token identifiers, calculating a key and a value for an attention model based on the first set of embedding vectors, and storing the key and the value within a session state data structure;
providing an application programming interface, the application programming interface configured to accept application programming interface instructions; and
responsive to receiving a first application programming interface instruction, defining a first session identifier that maps to a first key and a first value.

9. The method of claim 8, where defining the first session identifier comprises providing a set of prompts to a large language model and capturing the first key and the first value from the large language model.

10. The method of claim 9, further comprising:
responsive to receiving a second application programming interface instruction comprising the first session identifier, initializing a first session state data structure based on the first key and the first value.

11. The method of claim 8, where the first application programming interface instruction comprises a suspension instruction and where the first key and the first value are captured from a current conversation state.

12. The method of claim 11, further comprising:
responsive to receiving a second application programming interface instruction comprising the first session identifier, resuming the current conversation state based on the first key and the first value.

13. The method of claim 8, where the first session identifier is further associated with a geofence location.

14. The method of claim 8, where the first session identifier is further associated with a specific user.

15. An apparatus, comprising:
a network interface;
a large language model logic configured to calculate conversation states based on a mapping data structure, the large language model logic further configured to generate responses based on the conversation states;
a processor; and
a non-transitory computer-readable medium comprising instructions that when executed by the apparatus, cause the apparatus to:
establish a first session with a first client device, the first session comprising a first conversation state; and
provide an application programming interface that provides access to the mapping data structure or the first conversation state.

16. The apparatus of claim 15, where the application programming interface enables the first client device to define at least one mapping relationship between a first token and a first set of embedding vectors for the first session.

17. The apparatus of claim 15, where the application programming interface enables the first client device to set the first conversation state for the first session.

18. The apparatus of claim 15, where the application programming interface enables the first client device to suspend and recall the first conversation state.

19. The apparatus of claim 15, where the application programming interface enables a transfer of the first session to a second client device different than the first client device.

20. The apparatus of claim 19, where the first client device and the second client device are associated with a user.
